(19) United States
(12) Patent Application Publication
(10) Pub. No.: US 2026/0155658 A1
(43) Pub. Date: Jun. 4, 2026

(54) BATTERY PACK CONTROL SYSTEM

(71) Applicant: Redwood Materials, Inc., Carson City, NV (US)

(72) Inventors: Colin Campbell, San Francisco, CA (US); JB Straubel, Washoe Valley, NV (US); Nancy Sun, Oakland, CA (US); Jeff Ransdell, Reno, NV (US)

(21) Appl. No.: 19/401,060

(22) Filed: Nov. 25, 2025

Related U.S. Application Data
(60) Provisional application No. 63/726,515, filed on Nov. 30, 2024.

(51) Int. Cl. H02J 7/00; B60L 3/00; B60L 58/12; H01M 10/42; H01M 50/249; H02J 3/32

(52) U.S. Cl. CPC H02J 7/485; B60L 3/0046; B60L 58/12; H01M 10/425; H01M 50/249; H02J 3/32; H02J 7/52; H02J 7/663; H02J 7/977; B60L 2240/545; B60L 2240/547; B60L 2240/549; H01M 2010/4271; H01M 2220/20; H02J 2207/20

(57) ABSTRACT

The present disclosure relates to systems and methods for utilizing second-life electric vehicle (EV) batteries as part of a battery energy storage system. In particular, in one or more embodiments, the disclosed systems provide a battery control system that enables use of multiple different types of batteries from different manufacturers and with different chemistries. For example, a site controller oversees system operation by receiving battery-status data from the various battery-management systems, directing inverter blocks to manage power flow among the battery packs, and routing energy to the appropriate loads. At the battery pack level, a pack manager device communicates with individual battery packs from different manufacturers, converts the battery-specific voltage into a standardized direct-current bus level, and regulates battery pack behavior based on reported operating parameters to maintain safe, reliable performance. By so doing, one or more embodiments provide for secondary use of used or partially degraded batteries.

### CROSS-REFERENCE TO RELATED APPLICATIONS

This application claims priority to and the benefit of U.S. Provisional Patent Application No. 63/726,515, filed on Nov. 30, 2024, which is incorporated herein by reference in its entirety.

### BACKGROUND

Recent years have seen a significant increase in the implementation of various types of batteries as an alternative to fossil fuels and other sources of energy. Moreover, the recent surge in popularity of electric vehicles and other electronic devices containing batteries has resulted in a significant increase in demand for battery production, as well as an increased demand for safe and efficient recycling of batteries and battery materials. Specifically, batteries naturally degrade over time, leading to reduced storage capacity and shortened usable life. In addition, the chemical composition of many batteries introduces risks of instability and toxicity, creating difficulties in both continued operation and eventual disposal. In electric vehicles, this degradation becomes significant when batteries lose approximately 25% to 30% of their original charge capacity, which typically occurs after five to ten years of use.

### BRIEF SUMMARY

Embodiments of the present disclosure provide benefits and/or solve one or more of the foregoing or other problems in the art with systems, devices, and methods for utilizing electric vehicle (EV) batteries as part of a battery energy storage system. Specifically, the used or partially degraded batteries are utilized to provide, initially, off grid power when paired with a power source. The disclosed systems also utilize a battery control system that enables use of multiple different types of batteries from different manufacturers with different chemistries. The disclosed systems include an energy-management architecture that coordinates one or more energy sources with heterogeneous second-life battery packs. For example, a site controller oversees system operation by receiving battery-status data from the various battery-management systems, directing inverter blocks to manage power flow among the battery packs, and routing energy to the appropriate loads. At the battery pack level, a pack manager device communicates with individual battery packs from different manufacturers, converts the battery-specific voltage into a standardized DC (direct-current) bus level, and regulates battery pack behavior based on reported operating parameters to maintain safe, reliable performance. By so doing, one or more embodiments provide for secondary use of used or partially degraded batteries and reduce negative environmental impacts of used or partially degraded batteries while also providing a clean energy solution.

### BRIEF DESCRIPTION OF THE DRAWINGS

The detailed description provides one or more embodiments with additional specificity and detail through the use of the accompanying drawings, as briefly described below.

FIG. 1 illustrates a diagram of a battery energy storage system as part of a battery energy storage system in accordance with one or more embodiments.

FIG. 2 illustrates an example of an enlarged view of the distributed architecture for a battery energy storage system in accordance with one or more embodiments.

FIG. 3 illustrates a representation of an inverter block of the battery energy storage system in accordance with one or more embodiments.

FIG. 4 illustrates an example combiner block of the battery energy storage system in accordance with one or more embodiments.

FIGS. 5A-5B illustrate example disconnect implementations for the battery energy storage system in accordance with one or more embodiments.

FIGS. 6A-6B illustrate example racking implementations for the battery energy storage system in accordance with one or more embodiments.

FIG. 7 illustrates an example vertical racking structure for the battery energy storage system in accordance with one or more embodiments.

FIG. 8 illustrates an example horizontal racking structure for the battery energy storage system in accordance with one or more embodiments.

FIG. 9 illustrates an example thermal-monitoring arrangement for battery packs in accordance with one or more embodiments.

FIG. 10 illustrates an example fire suppression implementation for a battery pack utilizing a fire-resistant casing in accordance with one or more embodiments

FIG. 11 illustrates an example pack manager of the battery energy storage system in accordance with one or more embodiments.

FIG. 12 illustrates an example configuration for a pack manager within the battery energy storage system in accordance with one or more embodiments.

FIGS. 13A-13C illustrate additional example configurations for pack managers within the battery energy storage system in accordance with one or more embodiments.

FIG. 14 illustrates an example physical design for a pack manager of the battery energy storage system in accordance with one or more embodiments.

FIG. 15 is a diagram illustrating pack managers performing battery pack isolation and monitoring in accordance with one or more embodiments.

FIG. 16 illustrates an example DC droop curve used by the battery energy storage system to regulate the charge and discharge current of a battery pack using a pack manager in accordance with one or more embodiments.

FIG. 17 is an example diagram of the software architecture for a pack manager in accordance with one or more embodiments.

FIG. 18 illustrates an example state machine representing the operation of a pack manager in accordance with one or more embodiments.

FIGS. 19A-19B illustrate graphs that quantify pack manager efficiency for the battery energy storage system in accordance with one or more embodiments.

FIG. 20A is an example flowchart representing the operation of a battery energy storage system in accordance with one or more embodiments.

FIG. 20B is an example flowchart representing the operation of a pack manager of a battery energy storage system in accordance with one or more embodiments.

FIG. 21 illustrates a block diagram of an example computing device in accordance with one or more embodiments.

### DETAILED DESCRIPTION

One or more embodiments include a battery energy storage system that enables secondary use of batteries as part of a clean energy solution, thereby reducing the environmental impact of new, used, and/or partially degraded batteries. Specifically, in one or more embodiments, the used or partially degraded batteries are utilized to provide, initially, off grid power when paired with a solar array or other power source. The disclosed systems also utilize a battery pack manager that enables use of multiple different types of batteries from different manufacturers (e.g., recovered from electric vehicles) with different operating voltages, battery chemistries, or state-of-health. In this way, one or more embodiments of the battery energy storage system enable the integration of second-life batteries while maintaining a balanced operation of an overall energy system.

### Battery Energy Storage System

As mentioned, the battery energy storage system provides a modular, scalable architecture for integrating heterogeneous second-life battery packs into a unified storage and power-delivery platform. Utilizing the illustrated architecture, the battery energy storage system integrates disparate battery packs from different manufacturers and with differing electrical characteristics and state-of-life.

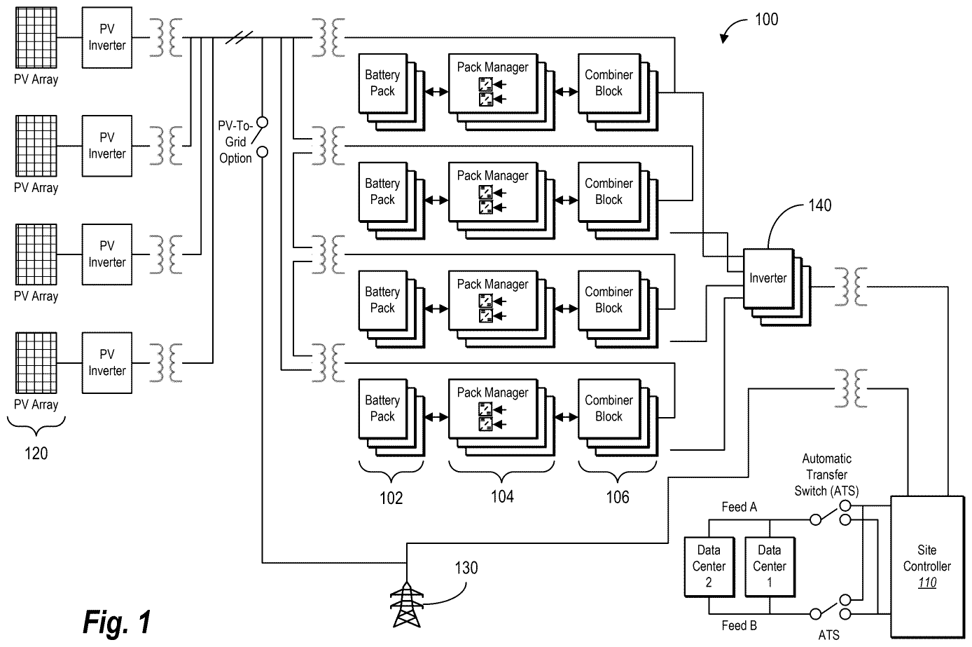

For instance, FIG. 1 illustrates a diagram of a battery energy storage system as part of a power system 100 in accordance with one or more embodiments. As shown, the power system 100 includes energy sources 120 that generate power such as photovoltaic (PV) arrays of solar panels that that capture solar energy and generate electricity (or other renewable or distributed resources). One will appreciate that the energy sources could be wind or water turbines or other more traditional power sources. In certain deployments, the system may also be supplied by utility grid power, on-site cogeneration units, natural-gas turbines, diesel generators, or any other available AC or DC energy source capable of interfacing with the inverter block or site controller. The power system 100 further includes a battery energy storage system comprising at least one or more used or partially degraded batteries (e.g., EV batteries) that store energy generated by the energy sources 120. When an external electrical grid 130 (illustrated by the power pole) fails or otherwise stops providing power, the battery energy storage system provides power to a data center or other power consuming system to help ensure uninterrupted electricity. Specifically, an Automatic Transfer Switch (ATS) is included for redundancy, ensuring uninterrupted power supply in case one power source feed fails. Additionally, excess power generated by the energy sources 120 can be fed back to the external electrical grid 130 via a high-voltage transmission line, as shown on the bottom right of FIG. 1. Thus, FIG. 1 illustrates how renewable energy from the energy sources 120 is integrated with secondary use batteries that provide storage to ensure a reliable and sustainable power supply to data centers (or other power consuming systems), with provisions for grid connectivity and redundancy.

The battery energy storage system can be configured for megawatt-scale operation in both on-grid and off-grid applications (e.g., grid-following mode or a grid-forming mode). For example, the battery energy storage system provides grid-support functions such as frequency regulation, voltage stabilization, peak-shaving, and backup power for large facilities including data centers, industrial plants, microgrids, or utility distribution nodes. Moreover, the battery energy storage system can be deployed in a variety of configurations including connecting to the external electrical grid 130, supplying power to a load facility such as a data center, or operating independently in an islanded mode, and may further support energy-arbitrage operations by charging or discharging in response to real-time or scheduled grid-price signals.

As illustrated, in one or more embodiments, the battery energy storage system utilizes a site controller 110 to coordinate downstream devices to satisfy the power requirements of the power system 100. The site controller 110 can balance energy across a plurality of disparate battery packs (e.g., battery packs 102), while respecting the individual power limits of the battery packs 102 and the pack managers 104. In particular, the site controller 110 utilizes the pack managers 104 to manage the battery packs 102 including disparate second-life battery packs that originate from different manufacturers, exhibit different nominal voltages, and reflect different stages of degradation (e.g., states-of-health). In this way, the battery energy storage system can adjust voltage, frequency, or power output from the battery packs 102 to satisfy the power requirements of the power system 100.

As further illustrated, the battery energy storage system utilizes pack managers 104 to manage the battery packs 102. For example, the battery energy storage system utilizes the pack managers 104 to provide a consistent interface to the battery packs 102 by interfacing with the battery management systems of the battery packs 102. The pack managers 104 also regulate the charge and discharge behavior for the battery packs 102 and ensure that each of the battery packs 102 operates within safe limits based on battery temperature, voltage, current, and state-of-health information.

In one or more embodiments, the techniques described herein apply not only to complete battery packs but also to individual battery modules. For example, the battery energy storage system can condition and normalize module-level data so that the collection of heterogeneous battery modules presents as a single logical battery pack with unified voltage, current, and communication characteristics. In one or more embodiments, for deployments that utilize module-level integration, the battery energy storage system may incorporate a modular battery-management subsystem configured to interface with heterogeneous battery modules originating from different manufacturers, chemistries, form factors, and states-of-health. In some embodiments, each battery module may be equipped with a module-level BMS interface that reports voltage, temperature, state-of-charge, and protection status to a supervisory controller that aggregates telemetry across multiple modules. This module-level abstraction enables the battery energy storage system to accept disparate battery modules, manage them safely and independently, and combine them into a coherent energy source without requiring uniform chemistry, age, or capacity across the battery modules.

Moreover, in one or more embodiments, the battery energy storage system is not limited to integrating second-life battery packs or modules. Notably, the as described herein, the architecture of the battery energy storage system is equally compatible with new battery packs and newly manufactured battery modules. For example, the pack managers and supervisory module-level controllers are designed to recognize, characterize, and safely operate batteries regardless of prior usage history, manufacturing source, chemistry, or age. Newly produced battery packs or battery modules may be commissioned in the same manner as second-life batteries (through communication verification, voltage and temperature checks, and optional characterization cycles), after which the battery energy storage system establishes individualized operational limits and droop parameters. Because each battery unit interfaces through a dedicated pack manager or module controller that normalizes electrical and communication characteristics, the battery energy storage system can seamlessly incorporate combinations of brand-new, lightly used, and heavily aged batteries within the same installation, allowing flexible expansion and mixed-generation deployments without imposing uniformity requirements on the batteries themselves.

As also shown in FIG. 1, the battery energy storage system utilizes combiner blocks 106 to collect DC power outputs from multiple downstream pack managers (e.g., the pack managers 104), merge the DC power outputs onto a system DC bus, and relay aggregated status information upstream to the inverter 140. In addition to aggregating system power and communication signals, the combiner blocks 106 may translate communication protocols, such as converting CAN messages from the pack managers 104 into Ethernet or fiber links suitable for longer distances.

As mentioned, the battery energy storage system can operate in a grid-following mode or a grid-forming mode to satisfy the power requirements of the power system 100. For example, the battery energy storage system can employ the inverter 140 in a grid-following mode. When the battery energy storage system is connected to the external electrical grid, the battery energy storage system employs the inverter 140 in a grid-following mode in which the inverter 140 behaves as an alternating-current (AC) current source that injects controlled active and reactive power into the grid. In the grid-following mode, the site controller 110 supports scheduled operations as well as repeating schedules, autonomous savings, and market participation modes. In grid-following mode, the battery energy storage system regulates current magnitude and phase by causing the inverter 140 to synchronize to the grid voltage and frequency using a phase-locked loop or similar synchronization mechanism.

In some embodiments, the battery energy storage system can operate in a grid-forming mode. For example, when the battery energy storage system is operating in an islanded condition or during a grid outage, the site controller 110 causes the inverter 140 to behave as an AC voltage source configured to establish and maintain a stable voltage magnitude and frequency for an AC interface. In the grid-forming mode, the inverter 140 maintains specified output voltage and frequency setpoints and adjust current to meet the connected load demand. In grid-forming mode, the battery energy storage system uses droop-control relationships between voltage and frequency to support balanced power-sharing among the inverters.

In one or more embodiments, the battery energy storage system addresses several shortcomings of existing battery energy storage systems. For example, many existing energy-storage systems cannot accommodate for the variability inherent in second-life battery packs or battery packs with disparate characteristics (e.g., chemistry, voltage range, degradation level, or communication protocol). These existing battery energy storage systems often treat all battery packs as electrically identical units and therefore require uniform characteristics when incorporating multiple battery packs into the system. As a result, existing battery energy storage systems lack the ability to adjust charge and/or discharge behavior to match the capability of each individual battery pack. Nor can existing battery energy storage systems compensate for differences between disparate battery packs including current contribution, voltage limits, state-of-health, available capacity, or internal resistance.

Relatedly, in many existing battery energy storage systems, the failure or degradation of a single battery pack can require replacement of an entire battery string to maintain electrical uniformity, leading to unnecessary waste and extended downtime. In existing battery energy storage systems without pack-specific power conversion hardware, a low-voltage or degraded pack can restrict the current or voltage available from the entire group, and a fault in one pack can introduce disturbances onto the shared DC bus, reducing overall system stability. These limitations of existing battery energy storage systems can accelerate degradation across the battery packs, increase imbalance among battery packs, and ultimately reduce the usable life of the system.

Moreover, many existing battery energy storage systems house large numbers of battery packs inside a single shipping container or enclosure. The tightly packed configuration of these existing battery energy storage systems limits airflow, increases the difficulty of dissipating heat during operation, and increases the risk that a failure in an individual battery pack may spread to adjacent battery packs due to close physical proximity. The containerized layouts of existing energy-storage systems also restricts access for inspection, maintenance, and replacement, often requiring specialized procedures. Moreover, in many existing energy-storage systems, a fault in an individual battery pack may require removal of an entire block or string (often requiring full system shutdowns).

As described herein, the battery energy storage system provides several advantages compared to existing battery energy storage systems. In particular, the battery energy storage system enables the integration of second-life electrical vehicle battery packs from different manufacturers, chemistries, capabilities, and degradation profiles as a coordinated energy source. For example, the battery energy storage system connects each disparate battery pack through a dedicated pack manager that performs protocol translation, voltage conversion, current regulation, and various safety functions. By abstracting the electrical and communication characteristics of each battery pack in this way, the battery energy storage system prevents weaker or lower-capacity battery packs from limiting system performance and enables each battery pack to contribute according to its actual capability. Indeed, the battery energy storage system solves a fundamental barrier in second-life battery pack reuse, where inconsistent voltages, varying communication protocols, and unequal aging typically prevent safe aggregation of disparate battery packs.

Moreover, the battery energy storage system scales naturally from small installations to megawatt-scale deployments utilizing a site controller that manages the overall system, supporting both grid-following and grid-forming modes. By distributing specific functions to modular downstream devices (e.g., inverters, combiner boxes, pack managers), the battery energy storage system provides advantages in scale, responsiveness, and control adaptability over existing battery energy storage systems. In addition, the battery energy storage system utilizes pack managers for fine-grained isolation and control, allowing each battery pack to operate independently from the other battery packs. If a battery pack exhibits degraded performance or a fault condition, the corresponding pack manager autonomously limits current, opens contactors, or transitions to a safe state without affecting the rest of the system. As a result, with the battery energy storage system, maintenance can be performed on a per-pack basis without replacing entire battery strings or triggering full-system shutdowns.

Furthermore, the battery energy storage system provides advantages through an outdoor layout that spaces battery packs in open air rather than concentrating the battery packs within large, containerized enclosures. For example, the battery energy storage system physically spaces the battery packs in modular structures separated by intentional clearances that limit heat accumulation and reduces the likelihood of thermal propagation between adjacent battery packs. Moreover, the battery energy storage system can incorporate fire-resistant barriers, protective side panels, directional shielding, and/or protective casings to further enhance overall fire safety and localize thermal failures. In addition, the distributed arrangement of the battery energy storage system allows maintenance personnel to service individual battery packs, pack managers, and/or combiner boxes without affecting or halting the operation of neighboring devices.

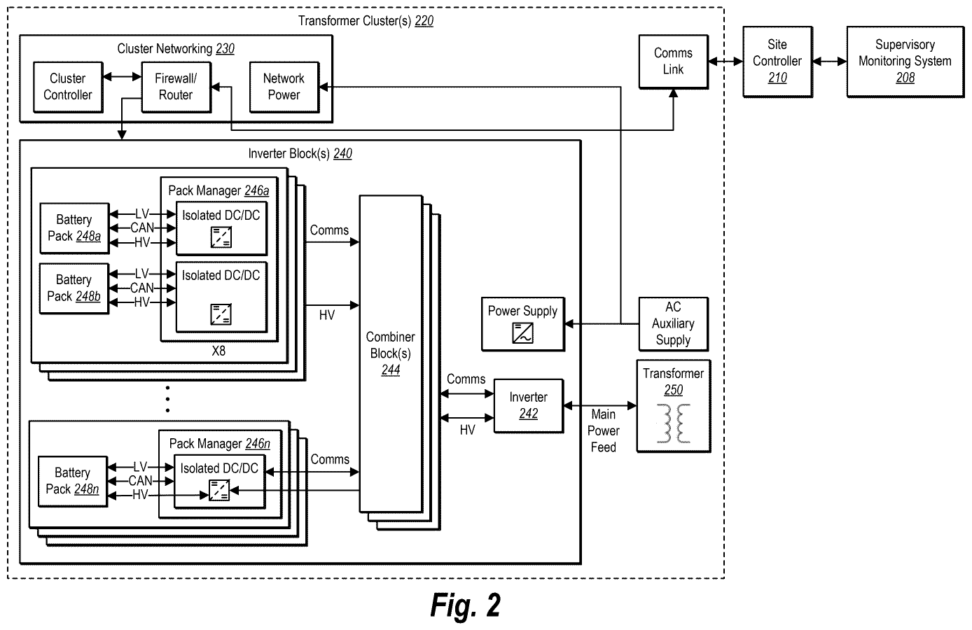

As mentioned, the battery energy storage system operates as a unified platform that integrates power sources, devices, and heterogeneous battery packs. FIG. 2 illustrates an example of an enlarged view of the distributed architecture for a battery energy storage system in accordance with one or more embodiments.

As shown in FIG. 2, the battery energy storage system 200 utilizes battery packs 248a-248n as the primary energy storage units, delivering direct-current (DC) power. Each of the battery packs 248a-248n is connected to a pack manager of the pack managers 246a-246n (e.g., through isolated DC/DC converters), which regulates and manages the DC power to ensure proper operation and efficiency. The regulated DC power from each of the pack managers 246a-246n is aggregated by the combiner block(s) 244 and fed into an inverter 242. The inverter 242 converts the DC power into alternating-current (AC) to make it compatible with the electrical grid or other AC-powered systems. Finally, the output from the inverter 242 is combined with the output from additional inverter block(s) 240 and passed through a transformer 250, which provides voltage transformation or isolation between the input and output. This modular design ensures scalability and reliability, allowing the battery energy storage system 200 to support high-capacity energy storage and grid-level applications.

For example, the battery energy storage system 200 includes one or more of the inverter block(s) 240, which serves to allow for utilization of energy stored in the battery packs. Moreover, the combiner block(s) 244 connects the inverter 242 to multiple pack managers 246a-246n, each of which is responsible for managing and regulating the flow of power between a specific battery pack (or more) and a DC bus. The inclusion of pack manager 246n and battery pack 248n, linked by a dashed line, highlights the scalability to accommodate any number (e.g., tens, hundreds, or thousands) of battery packs and pack managers. This architecture ensures centralized energy management while enabling decentralized storage, making the battery energy storage system 200 suitable for applications requiring modularity, redundancy, and adaptability.

To elaborate, in one or more embodiments, the battery energy storage system 200 utilizes a site controller 210 as a unified control and monitoring interface for the devices of the battery energy storage system 200. For example, the site controller 210 coordinates power flow between the devices of the transformer cluster(s) 220, performs state-of-charge balancing across the inverter block(s) 240, and manages the power flow for the battery packs 248a-248n. The site controller 210 also reports system metrics, battery data, and system data to the supervisory monitoring system 208.

In one or more embodiments, the site controller 210 incorporates forecast-driven scheduling and dispatch logic that combines information about environmental conditions, renewable-generation expectations, and anticipated user load profiles to optimize operation of the battery energy storage system 200. For example, the site controller 210 may account for predicted weather patterns, such as solar irradiance or temperature forecasts, when determining optimal charging windows for the battery packs 248a-248n supplied by photovoltaic arrays. Similarly, the site controller 210 may receive or infer upcoming large electrical loads from a facility, such as a data center, and coordinate battery pack availability to reduce peak grid demand, extend battery pack life, or shift energy usage into more favorable pricing periods. In some embodiments, the battery energy storage system 200 may also transmit forecast-based recommendations to a user device (such as anticipated low-solar periods or upcoming high-generation windows), allowing a user to batch or defer large computational or industrial tasks to reduce operational cost. By integrating environmental forecasts and user-load predictions into the dispatch plan, the battery energy storage system 200 enhances energy efficiency, improves battery longevity, and increases the economic value of both on-site storage and renewable-generation assets.

In one or more embodiments, the site controller 210 incorporates decision-support logic that evaluates when an individual battery pack provides greater value operating within the system versus being removed for recycling or repurposing. Using detailed telemetry from the pack managers 246a-246n, the battery energy storage system 200 can assess the remaining useful like and contribution potential of the battery packs 248a-248n. As degradation progresses, the site controller 210 can determine whether continued operation at a reduced charge/discharge rate delivers meaningful system-level benefit or whether a battery pack has entered a condition where recycling or refurbishment is more operationally advantageous. In some implementations, the site controller 210 generates automated recommendations or remote alerts when a battery pack projected lifetime energy throughput, efficiency contribution, or thermal reliability falls below predefined thresholds. In this way, the battery energy storage system 200 optimizes the removal of functioning second-life packs while ensuring timely retirement of units that no longer provide meaningful grid value (thereby reducing waste, lowering operational cost, and maximizing the lifecycle utility of the battery packs 248a-248n).

To manage the transformer cluster(s) 220, the site controller 210 interfaces with the transformer cluster(s) 220 through a communications link to send communications such as operational commands, telemetry data, configuration data, and monitoring information. In one or more embodiments, the site controller 210 utilizes one or more of the cluster networking devices 230 (e.g., cluster controller, a firewall/router, network power subsystem) to provide coordinated control, secure communications, and network availability for the battery energy storage system 200. For example, the site controller 210 utilizes the cluster controller to execute local supervisory functions, monitor health and status signals, and implement control commands. Moreover, the site controller 210 can utilize a firewall/router to enable secure routing for control commands and telemetry signals with the transformer cluster(s) 220. In some embodiments, the transformer cluster(s) 220 utilizes the cluster networking devices 230 to route power and communication signals to the inverter block(s) 240. As also shown, the transformer cluster(s) 220 can include an AC auxiliary supply, which provides power for networking devices, protection relays, transformers, or auxiliary loads required for startup and ongoing operation of the inverter block(s) 240.

In one or more embodiments, the battery energy storage system 200 utilizes the inverter block(s) 240 to provide a merged energy source for the transformer 250 (rather than providing a disconnected collection of disparate battery packs). For example, the inverter block(s) 240 convert the DC power collected from the battery packs 248a-248n into high-voltage (HV) DC power under the direction of the site controller 210. In some embodiments, the battery energy storage system 200 utilizes two or more of the inverter block(s) 240 in parallel behind the transformer 250. To illustrate, the battery energy storage system 200 can utilize a transformer 250 including a 480 V: 13.8 kV transformer, a 480 V: 4.15 kV, or other transformer with primary voltage levels such as 400-690 V and secondary volage levels such as 4.15-34.5 kV. The inverter block(s) 240 each include a high-capacity inverter (e.g., inverter 242) electrically coupled to the combiner block(s) 244.

The battery energy storage system 200 utilizes the inverter 242 to draw power from or deliver power to the battery packs 248a-248n. In particular, the inverter 242 converts aggregated direct-current power received from the combiner block(s) 244 into AC power suitable for export to a grid connection, a facility load, or an islanded microgrid. In one or more embodiments, the inverter 242 provides rated AC power of approximately 1.6 MVA at 480 VAC to the transformer 250. In certain embodiments, the inverter 242 provides rated AC power such as 1.0-3.0 MVA at 400-690 VAC (depending on site requirements, standards, or constraints). In certain embodiments, the battery energy storage system 200 the inverter 242 represents multiple parallel inverters (e.g., two 1.5 MVA inverters for a 3 MVA transformer), while preserving the illustrated hierarchical architecture between the inverter block(s) 240 and the transformer 250.

As further illustrated, in one or more embodiments, the inverter block(s) 240 includes the combiner block(s) 244. As used herein, the combiner block(s) 244 refer to hardware and communication circuitry that aggregates DC power and communication channels from multiple pack managers. The combiner block(s) 244 may be implemented as, or include, one or more combiner boxes that provide fused or non-fused DC aggregation. In one or more embodiments, the battery energy storage system 200 utilizes the combiner block(s) 244 to enable the system to scale to support large numbers of the battery packs 248a-248n.

For example, the battery energy storage system 200 utilizes the combiner block(s) 244 to aggregate the outputs of the pack managers 246a-246n. Through the combiner block(s) 244, the battery energy storage system 200 enables the inverter block(s) 240 to interface with a large population of battery packs without requiring the inverter 242 to manage individual pack behaviors or communication protocols. The combiner block(s) 244 is coupled to the inverter 242 using a standardized HV DC (e.g., 1400 V) interface that aggregates the DC outputs (e.g., 1400 V) of the pack managers 246a-246n and a communication channel that interprets or consolidates operational data from the pack managers 246a-246n.

As further shown in FIG. 2, the battery energy storage system 200 utilizes the pack managers 246a-246n as an intelligent interface positioned between the battery packs 248a-248n and the combiner block(s) 244. As shown, each of the pack managers 246a-246n manages a connected battery pack (or a pair of connected battery packs). Because the battery packs 248a-248n may originate from different electrical vehicle manufacturers and may have different electrical capabilities, the pack managers 246a-246n act as a normalizing layer, converting pack-specific voltages into a standardized DC bus voltage and translating pack-specific communication protocols for the battery packs 248a-248n into a common communication interface. The pack managers 246a-246n also provide the electrical, communication, and safety functions necessary to integrate a heterogeneous collection of second-life battery packs (e.g., the battery packs 248a-248n) into the battery energy storage system 200.

Moreover, in certain embodiments, the pack managers 246a-246n regulate bidirectional power flow through internal isolated DC/DC converters to ensure that each of the battery packs 248a-248n contributes to the battery energy storage system 200 according to individual battery pack capability and state-of-health. For example, the battery energy storage system 200 utilizes the battery pack managers 246a-246n to allocate power delivery from the battery packs 248a-248n and equalize the state-of-charge across the battery packs 248a-248n. Moreover, the battery energy storage system 200 utilizes the battery pack managers 246a-246n to prioritize the power contribution from the individual battery packs of the battery packs 248a-248n based on differences in charging capability, battery pack chemistry, or battery pack degradation level.

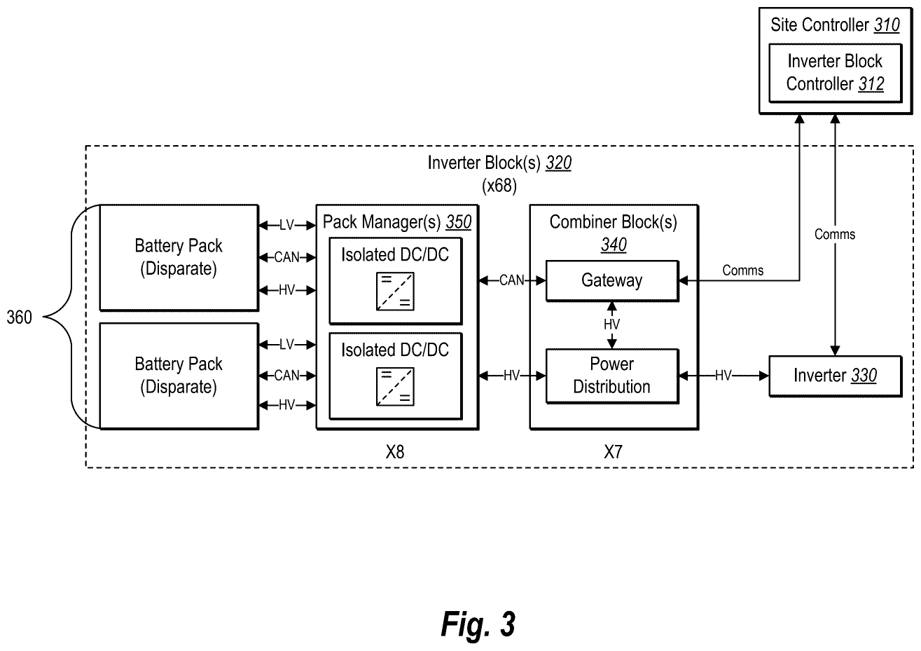

As mentioned, the battery energy storage system 200 can utilize one or more. inverter blocks to manage energy for a disparate battery packs. FIG. 3 illustrates a representation of an inverter block of the battery energy storage system in accordance with one or more embodiments.

FIG. 3 illustrates that the inverter block(s) 320 of the battery energy storage system 200 are designed for scalability and efficient energy management. For example, the battery energy storage system 200 utilizes a site controller 310 to manage the inverter block(s) 320 including an inverter 330 and associated downstream devices. In the illustrated example, the site controller 310 manages 68 of the inverter block(s) 320. Moreover, for each of the 68 instances of the inverter block(s) 320, the battery energy storage system 200 couples 7 combiner block(s) 340 to the inverter 330. Moreover, each of the 7 combiner block(s) 340 aggregates the outputs for 8 pack manager(s) 350. In turn, each of the 8 pack manager(s) 350, manages 2 of the battery packs 360. The illustrated configuration allows the battery energy storage system 200 to support more than one hundred second-life battery packs for a single instance of the inverter block(s) 320. Notably, the counts for the devices illustrated in FIG. 3 correspond to a representative embodiment of the inverter block(s) 320 for the battery energy storage system 200. In one or more embodiments, the battery energy storage system 200 utilizes the site controller 310 to manage installations with larger or smaller device counts for the inverter 330, the combiner block(s) 340, the pack manager(s) 350, and/or the battery packs 360.

As also shown in FIG. 3, the battery energy storage system 200 utilizes various communication interfaces between the site controller 310, inverter 330, combiner block(s) 340, pack manager(s) 350, and/or the battery packs 360. Notably, although the CAN (e.g., Controller Area Network) protocol and high-bandwidth comms links are illustrated, a variety of communication protocols and physical layers may be used depending on system design requirements.

As illustrated in FIG. 3, the site controller 310 exchanges operational commands, telemetry, and configuration data with the inverter 330 and the combiner block(s) 340 over a high-bandwidth comms link (e.g., Ethernet, fiber, or another suitable digital communication channel). Utilizing the high-bandwidth comms link the site controller 310 can provide power commands to the inverter 330 such as active and reactive power commands, droop-slope adjustments, grid-following configuration, or grid-forming configuration. Moreover, the inverter 330 can utilize the high-bandwidth comms link to provide information such as inverter health status and real-time AC measurements such as voltage, frequency, and phase.

As also shown, the site controller 310 communicates with the combiner block(s) using a high-bandwidth comms link. The combiner block(s) 340 can utilize the high-bandwidth comms link to aggregate data from the pack manager(s) 350 and provide the site controller 310 with an up-to-date view of battery pack availability, state-of-charge distribution, fault conditions, and current or voltage limits. In turn, the site controller 310 can utilize the high-bandwidth comms link to dispatch control commands to the combiner block(s) 340 to respond rapidly to implement balancing strategies across the battery packs 360.

In addition, the combiner block(s) 340 communicate with the pack manager(s) 350 using a low-latency protocol, such as CAN. The pack manager(s) 350 can utilize a CAN link to transmit pack manager status messages such as battery pack availability, faults, state-of-charge, current limits, or power limits. In addition, the combiner block(s) 340 can utilize the CAN link to transmit information such as configuration data, droop parameters, enable/disable commands, and fault clear commands to the pack manager(s) 350.

Moreover, the pack manager(s) 350 similarly exchange pack-specific control and status information with the battery packs 360 using CAN or a similar pack-level protocol. For example, the pack manager(s) 350 utilize a CAN link to interface with the battery packs 360 internal battery management system (BMS) and send control messages, such as requests to close or open contactors, commands for wake or sleep modes, or requests for rate limiting or derating. The battery packs 360 can utilize the CAN link to provide data such as cell voltages, pack voltages, pack current, pack temperatures, state-of-charge, state-of-health, and faults to the pack manager(s) 350.

As also shown in FIG. 3, the battery energy storage system 200 incorporates power interfaces between the inverter 330, the combiner block(s) 340, the pack manager(s) 350, and/or the battery packs 360. As shown, the battery energy storage system 200 connects the battery packs 360 to the pack manager(s) 350 through a low-voltage interface for auxiliary power/control and through a high-voltage interface that corresponds to the operating voltage of the corresponding battery pack (e.g., 300-900 V). Moreover, the battery energy storage system 200 connects the pack manager(s) 350 to the combiner block(s) 340 to via a standardized HV DC interface to provide an HV DC output (e.g., 1400 V). The combiner block(s) 340 utilize a standardized HV DC interface to provide an aggregated HV DC output (e.g., 1400 V) from the pack manager(s) 350 to the inverter 330. The inverter 330 converts the aggregated HV DC output to AC power for a main power feed for delivery to a grid, a data-center load, or alternative load.

As mentioned, the battery energy storage system 200 can operate the inverter block(s) 320 in a grid-following and/or a grid-forming mode. When operating in the grid-following mode, the battery energy storage system 200 accepts active (P) and reactive (Q) power commands (e.g., through a customer interface). For the grid-following mode, the site controller 310 (or inverter block controller 312) provides control commands to the inverter 330 to synchronize the inverter block(s) 320 to an external grid and regulates real and reactive power output according to site-level objectives. For example, the battery energy storage system 200 manages the inverter 330 as a current-controlled device that adjusts AC output based on P-Q commands. In one or more embodiments, for grid-following mode, the site controller 310 uses the P-Q commands to synchronize the inverter 330 to the existing grid waveform and regulate real power output and reactive power output (e.g., using the local inverter measurements).

In grid-following mode, the battery energy storage system 200 maintains DC bus stability while providing grid-compliant voltage and frequency support on the AC interface. In grid-following mode, the site controller 310 can utilize the inverter block(s) 320 to schedule dispatch profiles, execute repeating time-based schedules, or enforce power limits. For example, the battery energy storage system 200 utilizes features such as an output ramp rate, active/reactive power priority, fixed power factor, volt-var curve, or volt-watt curve, frequency droop curve, voltage fault ride through curve, and frequency fault ride through curve.

The battery energy storage system 200 also utilizes the grid-following mode to enable autonomous economic behaviors. For example, in an autonomous savings mode, the site controller 310 manages the inverter block(s) 320 to minimize customer energy costs under a time-of-use tariff, evaluating both the energy component (kWh) and the demand component (kW). Moreover, in a market participation mode, the site controller 310 responds to real-time pricing, dispatch events, or market signals, to adjust power output or charging schedules for the inverter block(s) 320 to capture revenue or reduce operating costs.

In one or more embodiments, the battery energy storage system 200 operates in a grid-forming mode. When operating in the grid-forming mode, the battery energy storage system 200 operates as an AC voltage-controlled voltage source inverter and accepts voltage and frequency setpoints. For the grid-forming mode, the battery energy storage system 200 operates the inverter block(s) 320 in parallel to support loads and distributed generation on a microgrid.

For grid-forming mode, the battery energy storage system 200 manages inverter-level power sharing utilizing an AC droop control strategy. For example, the site controller 310 manages the inverter block(s) 320 based on AC droop laws. The site controller 310 defines how each inverter adjusts voltage and frequency based on local measurements of power output (e.g., determining frequency and voltage droop setpoints based on the available energy and subject to available power constraints.). In this way, the site controller 310 utilizes local droop control to adjust the frequency and voltage droop setpoints for closed-loop current control and ensure that the inverters, including the inverter 330, contribute an appropriate share of real and reactive power in response to system requirements.

To illustrate, for grid-forming mode, the site controller 310 provides active power sharing by modifying the output frequency of the inverter 330 in proportion to deviations in real power. During active-power regulation, the inverter 330 continuously compares measured real-power output against a nominal operating point and then adjusts the output frequency according to the linear droop characteristic. The inverter 330 adjusts its output frequency according to a linear droop function with respect to deviations in active power output, such as:

$$f = {f}_{nom} - {K}_{p} ( P - {P}_{setpoint} )$$

### Where:

f is the output frequency of the inverter
fₙₒₘ is the nominal system frequency
P is the measured active power output of the inverter
Pₛₑₜₚₒᵢₙₜ is the active power setpoint (zero unless secondary control is active)
Kₚ is the active power droop coefficient, expressed in Hz per Watt
   Simultaneously (or near simultaneously), the site controller 310 provides reactive power sharing by adjusting the output voltage magnitude for the inverter 330 in proportion to deviations in reactive power. The inverter 330 regulates its output voltage magnitude according to a linear droop function with respect to deviations in reactive power output, such as:

$$V = {V}_{nom} - {K}_{q} ( Q - {Q}_{setpoint} )$$

### Where:

V is the inverter output voltage magnitude
Vₙₒₘ is the nominal operating voltage
Q is the measured reactive power output
Qₛₑₜₚₒᵢₙₜ is the reactive power setpoint (zero unless secondary control is active)
K_{q} is the reactive power droop coefficient, expressed in Volts per VAR

In some embodiments, the battery energy storage system 200 utilizes a secondary control to correct long-term imbalances in available energy or power capability across the inverter block(s) 320. For example, if adjusting the droop slopes alone is insufficient to equalize the state-of-energy of the DC buses, the battery energy storage system 200 modifies the nominal frequency reference to intentionally charge or discharge one or more of the inverter block(s) 320. In this way, the battery energy storage system 200 utilizes a secondary control to maintain energy balance while preserving the autonomous stability provided by primary droop control for the inverter block(s) 320.

In one or more embodiments, the site controller 310 operates to automatically detect grid connection status and perform a controlled transition between the grid-following mode and the grid-forming mode. For example, during a transition to grid-forming mode, the battery energy storage system 200 can operate the inverter block(s) 320 to ramp output voltage amplitude and frequency to maintain continuity of power supply to local loads. Upon grid restoration, the battery energy storage system 200 can re-synchronize inverter phase, voltage, and frequency with the external grid and return the inverter block(s) 320 to grid-following mode. Moreover, in certain embodiments, the site controller 310 coordinates the inverter block(s) 320 such that one inverter block operates in the grid-forming mode to establish voltage and frequency references for a local AC bus, while the remaining inverter blocks operate in the grid-following mode to inject current based on the P-Q commands.

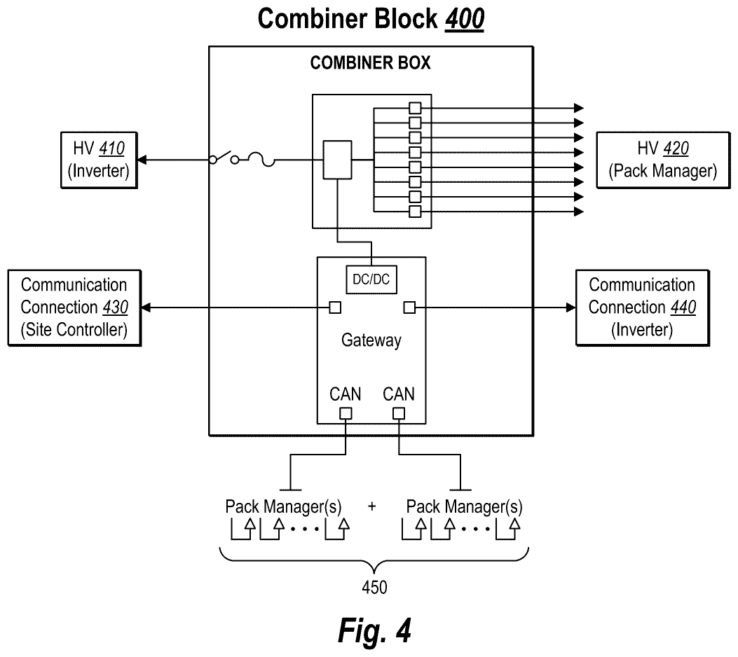

As mentioned, in one or more embodiments, the battery energy storage system 200 utilizes combiner blocks that function as central routing points linking the pack managers to inverter blocks and enabling reliable, scalable operation of large numbers of disparate second-life battery packs. FIG. 4 illustrates an example combiner block of the battery energy storage system 200 in accordance with one or more embodiments.

As illustrated in FIG. 4, combiner block 400 serves as both an electrical aggregation point for DC-bus power and a communication hub for multiple pack managers-linking pack-level, inverter-level, and site-level systems. For example, the combiner block aggregates and distributes both the DC bus power and the communication interface for a group of pack managers (e.g., eight pack managers associated with sixteen battery packs). The combiner block also integrates critical over-current protection, including fuses or breakers on each pack-manager input to protect against short-circuit faults on any individual battery pack. Additionally, the combiner block includes service disconnects that allow individual pack managers and battery packs to be safely isolated for maintenance without taking the entire inverter block offline.

For example, the combiner block 400 aggregates control signals from multiple pack managers within the battery energy storage system 200 using HV connection interfaces 420 that couple to a plurality of pack managers. The combiner block 400 utilizes the HV connection interfaces 420 to distribute a shared DC bus across the pack managers, enabling each of the pack managers to source or sink power to according to its droop control parameters and the capabilities of the corresponding battery pack(s). In one or more embodiments, the HV connection interfaces 420 incorporate fusing, protective disconnects, or configurations that permit maintenance or isolation of an individual pack manager without disrupting operation of the remaining pack managers connected to the combiner block 400.

The combiner block 400 further includes an HV connection interface 410 that couples the aggregated DC bus to an inverter. The combiner block 400 utilizes the HV connection interface 410 to deliver the aggregated DC-bus power sourced from the plurality of pack managers. The HV connection interface 410 carries the combined DC+ and DC− currents required by the inverter power conversion stage, forming the primary electrical link between the battery packs and the inverter.

As also illustrated in FIG. 4, the combiner block 400 incorporates communication interfaces that enable coordinated control between the site controller, the inverter, and the pack managers. For example, the combiner block 400 includes a communication connection interface 430 that provides a high-bandwidth communication link (e.g., Ethernet or fiber) between the combiner block 400 and the site controller. Through the communication connection interface 430, the combiner block 400 transmits aggregated battery pack telemetry and inverter-block information required for site-level supervisory control. Additionally, the combiner block 400 includes a communication connection interface 440 to the inverter, enabling coordinated operation within the inverter block. Through the communication connection interface 440, the combiner block transmits inverter-level commands and droop-parameter updates that allow the inverter block to regulate power flow among the pack managers and maintain stable inverter operation.

As further illustrated, the combiner block 400 includes communication connection interfaces 450 that provide communication links to the pack managers. In some embodiments, battery energy storage system 200 implements the communication connection interfaces 450 using CAN or a similar communication protocol. The combiner block 400 utilizes the communication connection interfaces 450 to exchange control messages and pack-specific telemetry with the pack managers. The illustrated configuration enables the combiner block 400 to translate and consolidate multiple CAN data streams from the pack managers into a high-speed interface for system-level supervisory control.

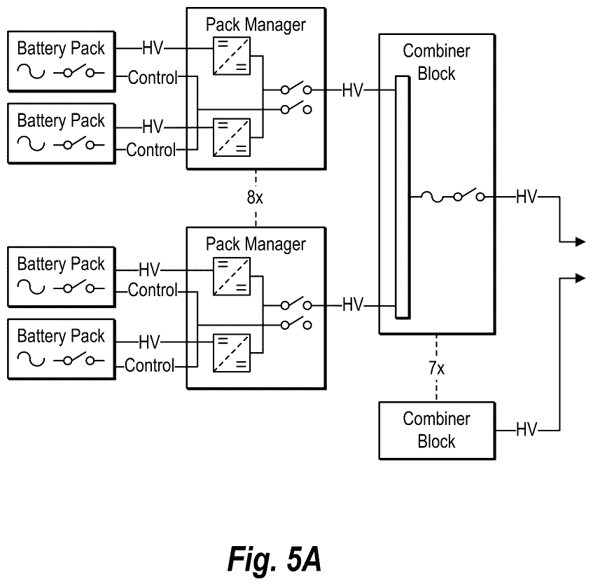

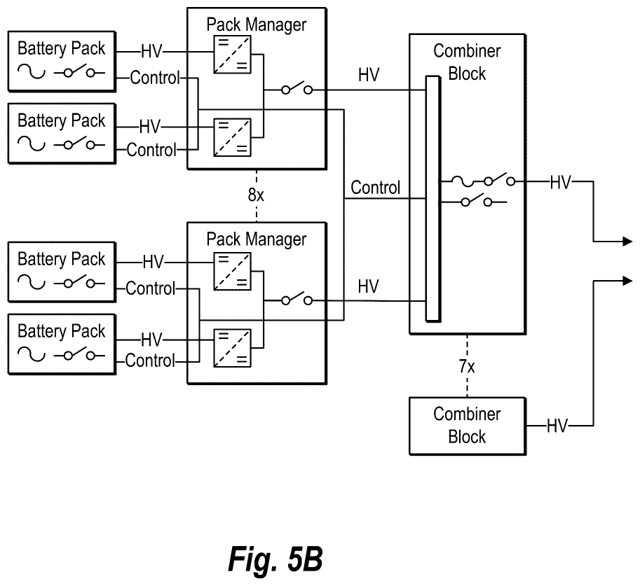

As mentioned, the battery energy storage system 200 is designed with a fault-tolerant architecture. For example, the battery energy storage system 200 supports multiple disconnect strategies to ensure safe isolation of individual battery packs or pack-managers. FIGS. 5A-5B illustrate example disconnect implementations for the battery energy storage system 200 in accordance with one or more embodiments.

As illustrated in FIGS. 5A-5B, the battery energy storage system 200 supports multiple disconnect strategies to detect, contain, and respond to abnormal conditions and ensure safe operation. Indeed, because the battery packs may exhibit different safety characteristics, the battery energy storage system 200 provides several levels of electrical and control isolation to maintain safe operation. For example, the battery energy storage system 200 includes hardware disconnects that isolate individual battery packs or pack managers during maintenance operations, fault conditions, thermal excursions, communication failures, or abnormal electrical behavior. In addition, the battery energy storage system 200 is configured to enable the rapid local recovery (e.g., automatic clearing) of non-latching faults without requiring intervention from higher-level controllers. Moreover, the battery energy storage system 200 is configured such that the loss of one or more devices does not compromise the stability of the overall system.

FIG. 5A illustrates an example disconnect strategy for the battery energy storage system 200. In FIG. 5A, the pack managers include a HV disconnect and a control-signal disconnect, while the combiner block also includes an HV disconnect. This configuration enables the pack managers to autonomously isolate affected battery packs from the combiner block in the event of a fault. Moreover, the combiner block includes a HV disconnect that provides a supplemental upstream protection for the inverter in the event of a fault. To illustrate, when a pack-level fault is detected (e.g., excessive cell voltage, thermal runaway indication, internal BMS fault, or communication loss), the pack manager can engage the HV disconnect and/or engage the control-signal disconnect to isolate the associated battery pack. If the combiner block determines that the pack manager failed to isolate the battery pack, the combiner block can engage an HV disconnect and protect the upstream devices.

FIG. 5B illustrates an alternate disconnect strategy for the battery energy storage system 200. In FIG. 5B, the battery energy storage system 200 incorporates a centralized a control disconnect and a HV disconnect within the combiner block. Moreover, the battery energy storage system 200 does not include separate HV disconnect hardware within the pack managers. In this configuration, the combiner block monitors telemetry data from the pack managers and the battery pack BMS and, upon detecting unsafe conditions, enables the HV disconnect to disable control communication for the affected pack manager. By centralizing the disconnect hardware within the combiner block, the battery energy storage system 200 simplifies the pack manager hardware which can be advantageous in cost-optimized or modular deployments.

In one or more embodiments, the battery energy storage system 200 can implement a hybrid disconnect strategy. For example, the battery energy storage system 200 can include a control-signal disconnect within the pack manager and include the primary HV disconnect within the combiner block. In this configuration, the pack manager can disable control signals in response to pack-level conditions, preventing further charge or discharge activity to place the battery pack in a safe state. Here, the combiner block engages the HV disconnect to cause the electrical isolation of the affected pack manager. The battery energy storage system 200 utilizes such an approach to reduce the hardware complexity of the pack manager while still allowing autonomous control-level isolation at the pack manager.

Moreover, in one or more embodiments, the battery energy storage system 200 incorporates software architecture to isolate devices in the event of a fault. For example, the battery energy storage system 200 incorporates a software architecture wherein, if the pack managers detect a fault, the pack managers are configured to isolate the associated battery packs. For example, if a pack manager detects a fault such as an over-voltage condition, under-voltage condition, thermal excursion, or internal BMS error, the pack manager is configured to isolate itself and associated battery packs by sending commands to the BMS to open the battery pack contactors and suspend power conversion. Moreover, the battery energy storage system 200 causes the remaining pack managers to automatically rebalance the system power (using DC droop control) and distribute power transfer across the remaining battery packs.

Similarly, the battery energy storage system 200 is designed to be tolerant of inverter-level faults. For example, the battery energy storage system 200 utilizes the site controller to continually monitor inverter availability and apply an inverter-power-sharing algorithm that redistributes power commands when one inverter becomes unavailable. If an inverter enters a fault state, the site controller maintains operation of the remaining inverters and automatically reallocates the real-power and reactive-power contributions to the non-faulted units, preventing the microgrid or connected loads from experiencing an unexpected loss of power capacity.

Moreover, for severe conditions, the battery energy storage system 200 operates to provide coordinated emergency de-energization. For example, the battery energy storage system 200 configures each of the power-electronic devices-including inverters, combiner boxes, and battery packs—to immediately disable power in the event of an emergency. When triggering the emergency stop, the battery energy storage system 200 issues commands for the battery pack contactors to open, removes power from the BMS modules of the affected battery packs, and forces the shared DC bus into a de-energized state. In some embodiments, the battery energy storage system 200 actuates the emergency-stop function at multiple layers, including using a client interface, an optional hardwired input on the site controller or power-unit controller, or a physical emergency-shutdown switch on site.

By implementing diverse disconnect strategies, the battery energy storage system 200 accommodates a range of operational priorities-including safety, maintainability, hardware cost, and pack-level autonomy. In this way, the battery energy storage system 200 can safely isolate individual battery packs without disrupting operation of all of the remaining battery packs.

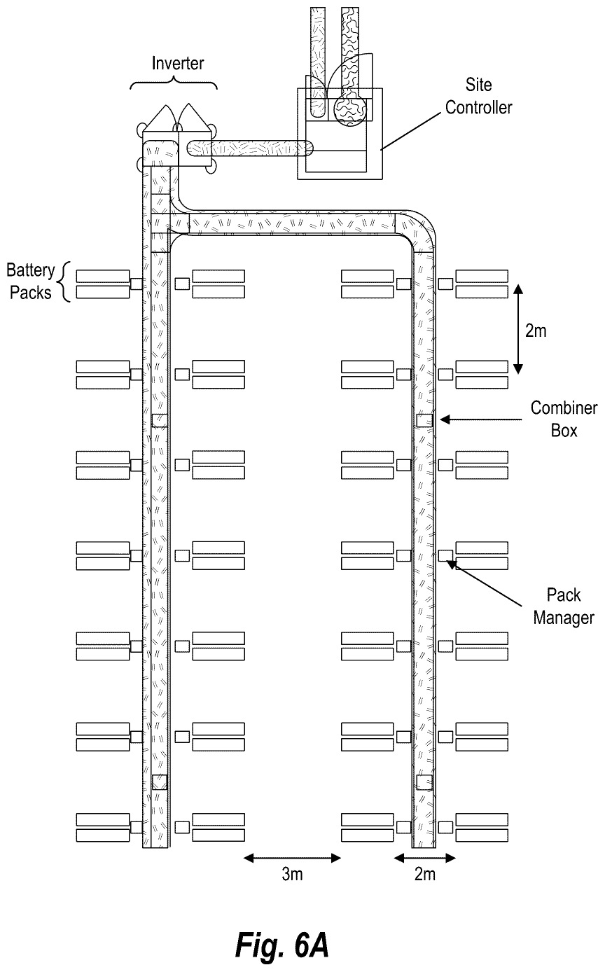

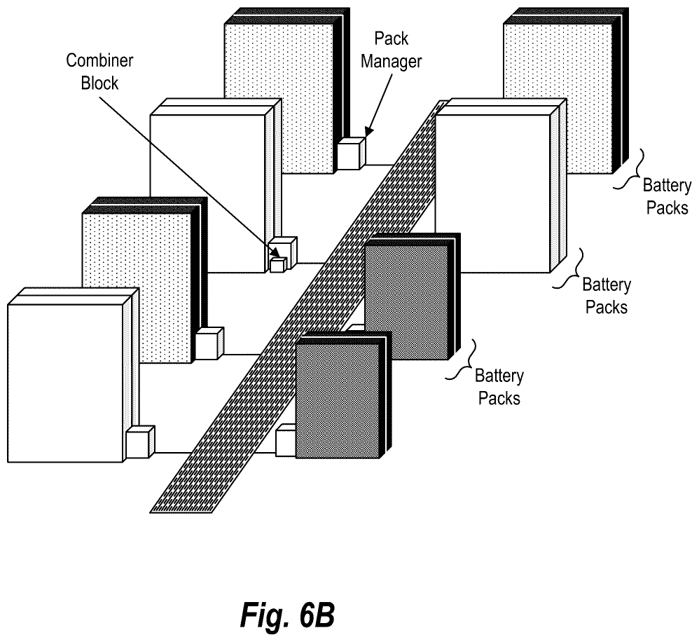

As mentioned, the battery energy storage system 200 incorporates heterogeneous second-life battery packs from different manufactures outdoor layout that spaces battery packs in open air rather than concentrating the battery packs within large, containerized enclosures. FIGS. 6A-6B illustrate example racking implementations for the battery energy storage system 200 in accordance with one or more embodiments.

As illustrated in FIG. 6A, the battery energy storage system 200 can be deployed in an open-air layout. As shown, the battery energy storage system 200 arranges the disparate battery packs in spaced-apart positions designed for safety, accessibility, and thermal robustness. As also shown, in one or more embodiments, the battery energy storage system 200 arranges the battery packs in pairs. Moreover, the open-air layout is further designed to accommodate the wide variety of physical footprints, voltage ranges, chemistries, and communication interfaces associated with common electric-vehicle battery modules, including but not limited to packs from different manufacturers.

As shown, in one or more embodiments, pairs of disparate battery packs are deployed in spaced-apart positions. By spacing the battery packs apart, such as by approximately two meters (or other distance), the battery energy storage system 200 reduces thermal coupling between units, significantly limiting the risk of thermal propagation and enabling each pack to dissipate heat more effectively under normal and fault conditions. Moreover, the spacing between the battery packs provides clear visibility of each battery pack for inspection and maintenance.

As also shown in FIG. 6A, the battery energy storage system 200 also includes dedicated drive aisles sized for forklift access (e.g., approximately three meters), The presence of forklift-accessible drive aisles allows individual packs to be installed, removed, or serviced without disturbing adjacent equipment, improving maintainability and minimizing downtime for the battery energy storage system 200. This flexible rack-and-aisle arrangement ultimately improves service access, operational safety, and scalability for large-scale distributed storage deployments.

In one or more embodiments, the battery energy storage system 200 supports hot-swapping of the battery packs-allowing a pack manager and its associated battery pack to be removed, replaced, or serviced without shutting down the system DC bus or de-energizing the inverter block. Because the battery energy storage system 200 couples each of the battery packs through a pack manager that contains independent DC/DC conversion hardware, contactors, and protection logic, the battery energy storage system 200 can safely disconnect an individual pack by opening its contactors, ceasing power conversion, and isolating the battery pack from the DC bus while keeping all other packs online. The combiner block and inverter block maintain stable DC bus voltage through remaining pack managers that continue sourcing or sinking power according to their droop characteristics. After mechanical replacement, the new battery pack may be detected automatically through communication and voltage-integrity checks before being recommissioned and brought online. The illustrated architecture enables field service, pack upgrades, and replacement of degraded second-life battery packs without requiring full system shutdown.

Moreover, as illustrated in FIG. 6B, the spaced-apart arrangement for the battery packs accommodates the varying form factors, dimensions, and mass of heterogeneous second-life battery packs from different manufacturers. Specifically, FIG. 6B illustrates three different sized second-life electrical vehicle battery packs from three different manufacturers. In one or more embodiments, the battery energy storage system 200 accommodates physical dimensions including approximately 1.7 m wide and 0.4 m deep. Moreover, the structural framework and pack enclosures are designed to support weather exposure, airflow, and passive cooling in outdoor environments. In some embodiments, the battery energy storage system 200 utilizes fire-resistant side panels or covers to further limit the spread of heat or flames between battery packs in the event of a pack-level fault.

Furthermore, in one or more embodiments, the distributed architecture of the battery energy storage system 200 enables controlled battery pack heating by shuttling energy between the battery packs through their corresponding pack managers. Because each pack manager includes an isolated bidirectional DC/DC converter capable of both sourcing and sinking current, the battery energy storage system 200 can intentionally circulate charge among selected packs to generate resistive heating within the targeted battery cells. In certain implementations, the site controller or inverter block controller initiates a round-robin charge-discharge sequence in which individual battery packs are briefly driven at higher current levels to produce the thermal output necessary for cold-weather conditioning. This heating sequence may be performed in several configurations, including cycling energy directly between a pair of battery packs or distributing energy from one battery pack into a larger group of packs (e.g., a cluster of seven or eight) to create the desired thermal rise in a controlled manner. By coordinating these charge-transfer patterns, the battery energy storage system 200 can warm specific battery packs rapidly while using the remaining packs to absorb or supply energy at lower rates, thereby maintaining pack health, balancing state-of-charge, and ensuring reliable low-temperature operation without the need for supplementary heaters.

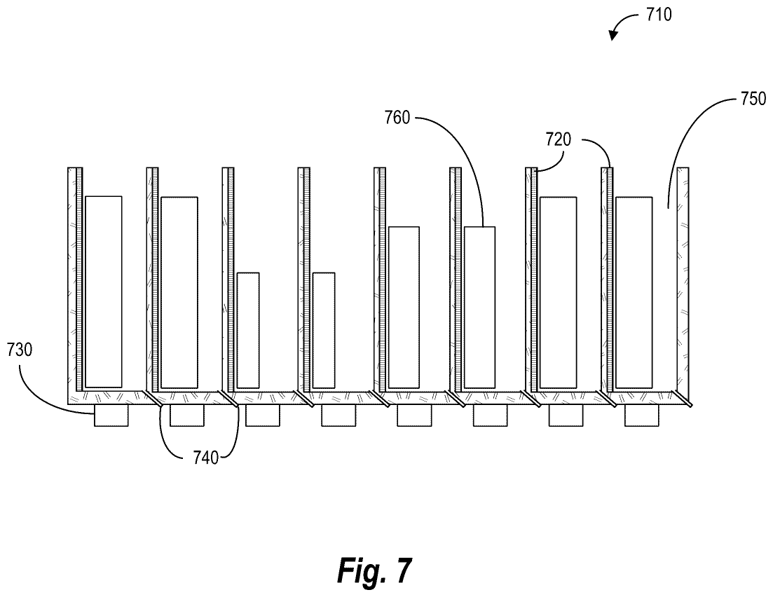

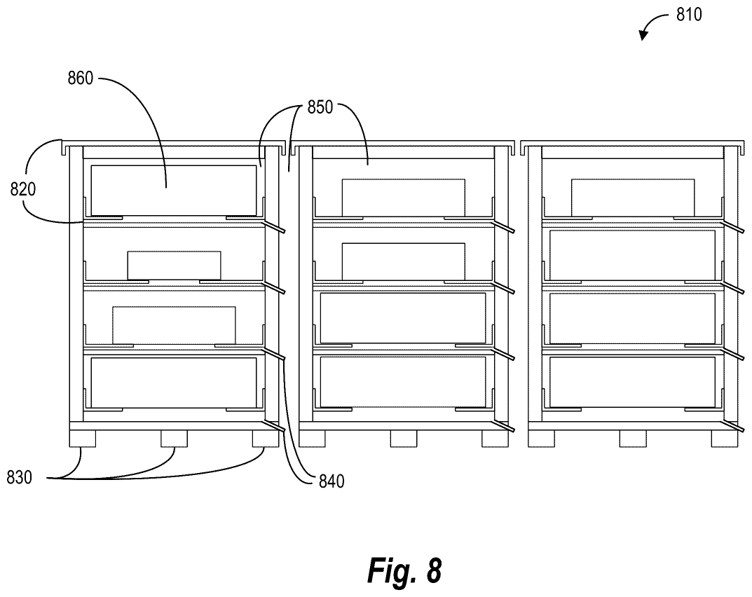

In one or more embodiments, the battery energy storage system 200 mounts the disparate battery packs on modular outdoor racks, which may be configured in horizontal or vertical orientations depending on site constraints. FIGS. 7-8 illustrate example racking structures for the battery energy storage system 200 in accordance with one or more embodiments

As illustrated in FIGS. 7-8, the battery energy storage system 200 incorporates racking structures that provide mechanical support, environmental protection, and maintenance accessibility for a plurality of disparate battery packs. As illustrated, the battery energy storage system 200 incorporates racking structures that can accommodate battery packs that exhibit different form factors, dimensions, or thermal behaviors. The battery energy storage system 200 may employ a stacked configuration, in which battery packs are arranged in horizontally or vertically oriented shelves or bays, permitting flexible installation layouts based on available space, airflow requirements, or user preference.

In one or more embodiments, the battery energy storage system 200 incorporates racking structures that facilitate operations within outdoor or semi-exposed environments continuously throughout all seasons, day and night (where ambient temperature, humidity, dust, and weather conditions vary significantly over time). The racking structures are fabricated from weather-resistant materials such as powder-coated steel or aluminum and include removable or hinged access panels to support maintenance operations. The racking structures (and corresponding components) of the battery energy storage system 200 can function at ambient temperatures of up to 50 degrees Celsius. The racking structures (and corresponding components) can withstand abrupt humidity changes, temperature changes, resist heavy rainfall, and are designed for outdoor use under Pollution Degree 4 standards.

As mentioned, FIG. 7 illustrates an example vertical racking structure for the battery energy storage system in accordance with one or more embodiments. In particular, FIG. 7 illustrates an example of a vertical racking structure 710 to mount individual disparate second-life battery packs (e.g., battery packs 760) in a structured, spaced-apart configuration. By positioning the battery packs 760 in an upright orientation with fire-resistant barriers 720 between adjacent battery packs, the vertical racking structure 710 reduces thermal coupling, limits the likelihood of fault propagation, and maintains predictable heat-dissipation pathways during high-load or abnormal events. Moreover, the vertical racking structure 710 also supports easier access for inspection, replacement, and forklift-assisted service, enabling individual battery modules to be removed or upgraded without disturbing neighboring battery packs. These characteristics make the vertical racking structure 710 particularly well-suited for accommodating heterogeneous second-life battery packs with varying dimensions, chemistries, and states-of-health while maintaining the safety and reliability required for large-scale outdoor energy-storage deployments.

In one or more embodiments, the vertical racking structure 710 includes fire-resistant barriers 720 positioned between the battery packs 760 or modules. The fire-resistant barriers 720 are constructed from high-temperature-rated materials designed to inhibit or delay heat transfer during a thermal event, preventing undesirable propagation from one of the battery packs 760 to adjacent battery packs. The fire-resistant barriers 720 additionally serve as physical partitions that define airflow channels to promote convection through the racking system (e.g., by blocking airflow between adjacent battery packs).

In some cases, the vertical racking structure 710 further includes ventilation pathways 750 or ducting features that promote airflow across the surfaces of the battery packs 760. For example, the battery energy storage system 200 utilizes the ventilation pathways 750 designed to support passive cooling or to direct airflow without relying on active cooling systems. In some cases, the battery energy storage system 200 utilizes the ventilation pathways 750 configured to permit airflow through the racking structures, allowing heat generated by the battery packs 760 and pack managers to dissipate naturally.

Moreover, the vertical racking structure 710 can incorporate drainage features designed to prevent water accumulation in exposed environments. For example, the vertical racking structure 710 may include weep holes weep holes 740, sloped surfaces, or gutter channels positioned within the enclosures to direct water away from the battery pack interfaces.

As also shown in FIG. 7, in some embodiments, the vertical racking structure 710 includes various support members (e.g. the supports 730) to position the battery packs 760 off the ground. In some cases, the supports 730 include forklift-accessible support members that allow entire racks or individual battery-pack trays to be moved, removed, or replaced using standard material handling equipment. In this way, the vertical racking structure 710 facilitates the installation, field servicing, and replacement of the battery packs 760 without requiring manual lifting or specialized equipment. In certain embodiments, the vertical racking structure 710 includes modular assemblies that enable scalable expansion or reduction of the vertical racking structure 710 through the addition or removal of individual battery packs or rack segments.

As mentioned, the battery energy storage system 200 utilizes a variety of racking structures to mount individual disparate second-life battery packs. FIG. 8 illustrates an example horizontal racking structure for the battery energy storage system in accordance with one or more embodiments.

As shown in FIG. 8, in one or more embodiments, the battery energy storage system 200 utilizes a horizontal racking structure 810 to mount individual disparate second-life battery packs (e.g., battery packs 860). In some cases, the battery energy storage system 200 utilizes the horizontal racking structure 810 to facilitate consistent airflow across pack surfaces, allow for straightforward drainage management, and support forklift or pallet-jack access for rapid removal and replacement of individual battery packs. In one or more embodiments, the geometry of the horizontal racking structure 810 inhibits ingress of rain, snow, sun, and debris to maintain safe operating conditions in outdoor environments. For example, the fire-resistant barriers 820 are designed to shield internal components from direct solar exposure and reduce radiant heating during peak ambient temperatures.

By positioning the battery packs 860 in a horizontal orientation with the fire-resistant barriers 820 between adjacent bays enhances pack-to-pack isolation during abnormal thermal events. The fire-resistant barriers 820 are constructed from high-temperature-rated materials designed to inhibit or delay heat transfer during a thermal event, preventing undesirable propagation from one battery pack to adjacent battery packs. In some embodiments, the horizontal racking structure 810 includes the fire-resistant barriers 820 such as fireproof roofing panels. The fire-resistant barriers 820 additionally serve as physical partitions that define airflow channels to promote convection through the racking system (e.g., by blocking airflow between adjacent battery packs).

In some cases, the horizontal racking structure 810 further includes ventilation pathways 850 or ducting features that promote airflow across the surfaces of the battery packs 860. For example, the battery energy storage system 200 utilizes the ventilation pathways 850 designed to support passive cooling or to direct airflow without relying on active cooling systems. For example, the battery energy storage system 200 utilizes the ventilation pathways 850 configured to permit airflow through the racking structures, allowing heat generated by the battery packs 860 and pack managers to dissipate naturally.

Moreover, the horizontal racking structure 810 can incorporate drainage features designed to prevent water accumulation in exposed environments. For example, the horizontal racking structure 810 may include weep holes weep holes 840, sloped surfaces, or gutter channels positioned within the enclosures to direct water away from the battery packs 860.

As also shown in FIG. 8, in some embodiments, the horizontal racking structure 810 includes various support members (e.g. the supports 830) to position the horizontal racking structure 810 off the ground. In some cases the supports 830 include forklift-accessible support members that allow sections of the horizontal racking structure 810 to be moved, removed, or replaced using standard material handling equipment. In this way, the horizontal racking structure 810 facilitates the installation, field servicing, and replacement of second-life battery packs without requiring manual lifting or specialized equipment. In certain embodiments, the horizontal racking structure 810 includes modular assemblies that enable scalable expansion or reduction of the horizontal racking structure 810 through the addition or removal of the battery packs 860 or rack segments.

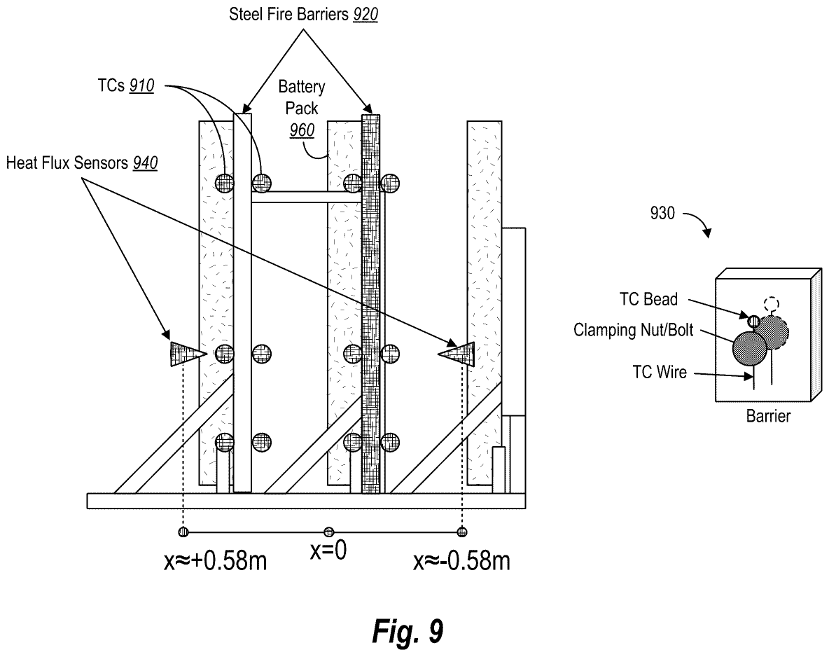

In one or more embodiments, the battery energy storage system 200 incorporates comprehensive thermal-monitoring to ensure the safe operation of the battery packs. FIG. 9 illustrates an example thermal-monitoring arrangement for battery packs in accordance with one or more embodiments.

As illustrated in FIG. 9, in one or more embodiments, the battery energy storage system 200 monitors the thermal behavior of the battery packs (e.g., battery pack 960). For example, the battery energy storage system 200 can incorporate a distributed set of thermocouples (e.g., TCs 910) to monitor thermal behavior of one or more of the battery packs. For example, the battery energy storage system 200 distributes the TCs 910 within and around the battery pack 960 and the associated mounting structure. In this way, the battery energy storage system 200 can comprehensively characterize internal pack temperatures, evaluate fire-barrier performance, and ensure safe operating conditions for adjacent battery packs.

In certain embodiments, the battery energy storage system 200 utilizes a total of twenty-four of the TCs 910 to characterize the mounting instrumentation of the battery pack 960 (as shown by the twelve thermocouples on the visible side of the mounting structure). In this embodiment, the battery energy storage system 200 positions eight of the TCs 910 within the interior of the battery pack to measure cell-level and module-level temperature variations during charging, discharging, or abnormal thermal events. The battery energy storage system 200 positions an additional six of the TCs 910 on the inner surface of the fire barrier (e.g., three on each side of the pack) to quantify heat transfer from the battery pack 960 into the barrier during elevated-temperature conditions. The battery energy storage system 200 mounts ten of the TCs 910 on the outer surface of the fire barriers 920 (e.g., five on each side) to assess the ability of the fire barriers 920 to contain heat and to verify that temperatures transmitted to neighboring packs remain within acceptable limits. To ensure reliable high-temperature measurements, the ten TCs are placed on either side of the fire barriers 920 are mechanically secured using bolts or similar fasteners, rather than adhesive tapes, which may lose adhesion or degrade under elevated temperatures (as shown by TC mounting hardware 930).

In some implementations, the battery energy storage system 200 further includes heat flux sensors 940 configured to measure radiant and convective heat transfer during normal operation and thermal-propagation events. As illustrated in FIG. 9, in certain embodiments, the battery energy storage system 200 deploys four of the heat flux sensors 940 around the representative battery pack installation. In the illustrated embodiments, two of the heat flux sensors 940 are positioned in neighboring pack locations to quantify the thermal energy transmitted toward adjacent packs (and to evaluate whether the fire-barrier structures or spacing strategies sufficiently inhibit heat propagation). In addition, two of the heat flux sensors 940 are positioned at a distance (e.g., approximately two meters from the sides of the battery pack) to capture far-field heat flux levels and assess environmental exposure, radiant heat dissipation, and compliance with safety setbacks.

Although twenty-four of the TCs 910 and four of the heat flux sensors 940 are illustrated in the embodiment of FIG. 9, these quantities and placements are intended as an illustrative example to demonstrate a suitable arrangement for the thermal characterization and safety validation of a battery pack. The illustrative embodiment of FIG. 9 does not limit the number, type, or configuration of sensors that may be used by the battery energy storage system 200. Other embodiments of the battery energy storage system 200 can incorporate additional, fewer, or differently arranged numbers of the TCs 910 and the heat flux sensors 940 depending on the desired level of monitoring, the characteristics of the battery packs, or site-specific safety requirements.

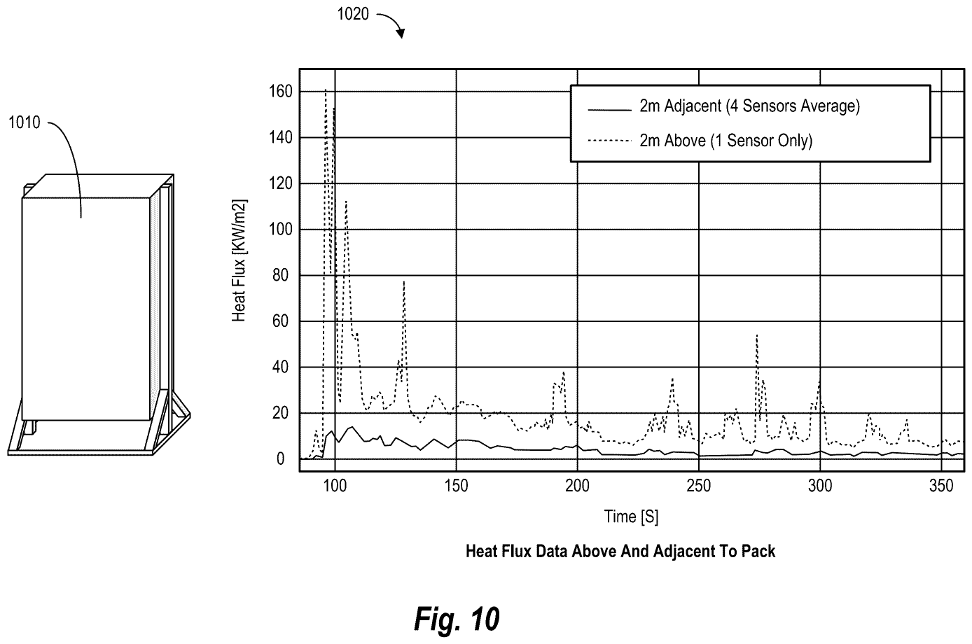

In one or more embodiments, the battery energy storage system 200 incorporates additional thermal suppression methods. FIG. 10 illustrates an example fire suppression implementation for a battery pack utilizing a fire-resistant casing in accordance with one or more embodiments.

As illustrated in FIG. 10, in some implementations, the battery energy storage system 200 encloses one or more of the disparate battery packs within a fire-resistant casing (or wraps with a fire-resistant cover) configured to reduce the risk of thermal propagation during a fault condition. For example, the battery energy storage system 200 utilizes a fire-resistant casing 1010 (or fire-resistant cover) formed from high-temperature-resistant materials such as ceramic insulation, woven fiberglass fabric, mineral wool, mica-based laminates, or multilayer composite thermal barriers. The fire-resistant casing 1010 is designed to contain heat, flame, and particulate release during a cell-level or module-level thermal event, thereby delaying or preventing transfer of heat to adjacent battery packs.

In one or more embodiments, the battery energy storage system 200 utilizes the fire-resistant casing 1010 to surround the battery pack on multiple sides. For example, the fire-resistant casing 1010 and may be integrated into the racking structure or applied directly to the battery pack module. In some embodiments, the fire-resistant casing 1010 includes expandable layers that activate under elevated temperatures to increase thermal isolation. The fire-resistant casing 1010 may further function as a physical partition that directs airflow or exhaust gases away from neighboring packs and assists in maintaining safe system operation.

As illustrated in FIG. 10, graph 1020 highlights the value of incorporating the fire-resistant casing 1010. In some cases, battery packs without adequate venting exhibited large transient flame jets and rupture events, producing an intense heat release. However, as shown by the graph 1020, when a battery pack is enclosed within the fire-resistant casing 1010, the measured heat flux at neighboring pack positions indicates that safe pack-to-pack spacing of less than approximately two meters is manageable without compromising battery pack safety. The graph 1020 further indicates that heat flux was nearly five times higher above the battery pack compared to adjacent lateral positions, demonstrating that the fire-resistant casing 1010 effectively limits horizontal heat transfer and prevents critical exposure to neighboring battery packs.

### Pack Manager Configuration

As previously mentioned, in one or more embodiments, the battery energy storage system 200 utilizes pack managers to manage disparate second-life battery packs with different battery chemistries due to variations in original manufacturer design, vehicle platform, or usage history. For example, the pack managers can manage battery packs with various chemistries including, but are not limited to, lithium-ion, lithium-iron-phosphate (LFP), nickel-manganese-cobalt (NMC), nickel-cobalt-aluminum (NCA), or other lithium-based chemistries. Each battery pack chemistry can exhibit distinct electrical characteristics, including nominal voltage per cell, allowable voltage range, charge-rate limitations, temperature-dependent performance, and aging behavior. As a result, the safe-operating-window parameters for each battery pack, such as permissible cell voltage limits, maximum charge and discharge currents, and thermal thresholds, may vary according to the underlying battery chemistry.

In one or more embodiments, the battery energy storage system 200 utilizes the pack managers to address several shortcomings of existing systems. For example, existing systems generally assume that all battery packs present uniform electrical and operational characteristics including matching chemistries, voltage ranges, degradation profiles, and communication interfaces. Because these existing systems treat battery packs as interchangeable units on a shared bus, they lack mechanisms to adapt charging or discharging behavior on a per-pack basis. As a result, existing systems cannot correct for meaningful differences in pack condition such as unequal current contribution, mismatched voltage limits, diverging state-of-health, uneven available capacity, or variations in internal resistance. This inability to account for pack-to-pack variability limits the use of heterogeneous or second-life batteries and can force system designers to rely only on tightly matched, homogeneous battery pack groupings.

Moreover, with many existing system architectures, the degradation or failure of a single battery pack compromises the behavior of every battery pack electrically connected to the same string. Because these existing systems lack pack-level power conversion hardware capable of isolating or conditioning individual battery packs, a single low-voltage, high-resistance, or otherwise degraded battery pack can constrain the available voltage or current for the entire battery string. To maintain consistency for these existing systems, maintenance personnel must often remove or replace an entire battery string, requiring a full system shutdown and generating unnecessary waste. Over time, the architecture limitations of these existing systems increase battery pack imbalance, accelerate battery pack degradation, and shorten the usable life of the battery packs.

Moreover, in one or more embodiments, the battery energy storage system 200 utilizes the pack managers to enhance system flexibility by enabling dynamic power optimization across a plurality of heterogeneous battery packs. Because each pack manager continuously evaluates voltage, state-of-health, internal resistance, and temperature metrics from the downstream battery pack, the battery energy storage system 200 can intelligently modulate charging and discharging currents to reflect the real-time capabilities of each battery pack. For example, the pack managers can perform charge and discharge adjustments for the battery packs locally through DC droop control, thereby reducing the dependence of the battery energy storage system 200 on centralized decision-making. In this way, the battery energy storage system 200 utilizes the pack managers to assign the battery packs with higher usable energy or better health a proportionally larger share of the load, while reducing the load for the more degraded or thermally restricted battery packs.

In addition, the pack managers significantly improve the scalability and configurability of the battery energy storage system 200. With the battery energy storage system 200, new battery packs (regardless of manufacturer, chemistry, or prior usage) can be introduced into the system simply by attaching them to a corresponding pack manager, without requiring recalibration of existing battery packs or reconfiguration of system-wide protection settings. The modularity enabled by the pack managers supports staged deployments, incremental capacity upgrades, and field replacement of individual battery packs in response to degradation or operational requirements. This modular architecture also supports distributed installations where battery packs are physically separated for thermal, fire-safety, or service-access reasons, yet still operate as a coherent energy-storage resource through the coordinated behavior of the pack managers. As a result, the battery energy storage system 200 achieves a level of extensibility and operational resilience that is not possible in conventional containerized, string-based energy-storage architectures.

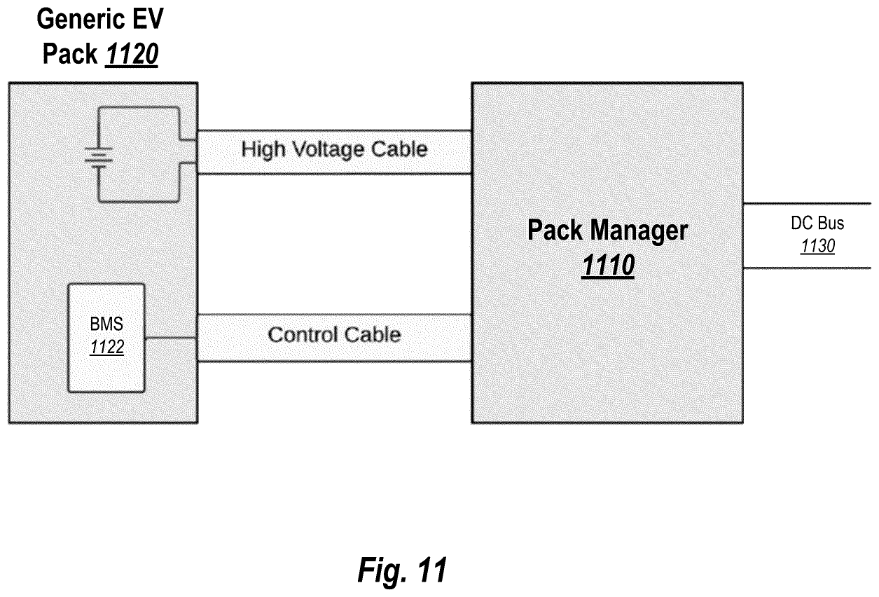

FIG. 11 illustrates an example pack manager of the battery energy storage system 200 in accordance with one or more embodiments. For example, FIG. 11 illustrates a pack manager 1110 utilized by the battery energy storage system 200 to integrate the generic EV pack 1120 with a system DC Bus 1130. The pack manager 1110 serves as an interface to integrate the generic EV pack 1120 with the system DC bus 1130 by converting native electrical and communication characteristics for the generic EV pack 1120 into a standardized form suitable for participation in the battery energy storage system 200.

In one or more embodiments, the pack manager 1110 detects and identifies a specific battery type, brand, and chemistry for the generic EV pack 1120 at startup. For example, the pack manager 1110 performs automatic pack detection to enhance operational efficiency and reduce the potential for human error during setup. The pack manager 1110 ensures that, with the correct cable connection in place, it is capable of identifying the power requirements of the BMS 1122 (Battery Management System) and automatically supplying the appropriate power. Once completed, the pack manager 1110 can autonomously proceed with further configuration and operation. This approach simplifies system deployment and enhances reliability by minimizing manual intervention while ensuring compatibility and functionality.

To elaborate, in one or more embodiments, the pack manager 1110 performs an automated commissioning process that enables newly installed battery packs (e.g., the generic EV pack 1120) to be rapidly integrated into the battery energy storage system 200 with minimal operator intervention. When a replacement or additional battery pack is connected to the pack manager 1110, the pack manager 1110 performs an initial validation sequence that includes communication-protocol detection, a low-voltage handshake, and verification of key telemetry channels such as pack voltage, temperature, and state-of-charge as reported by the BMS 1122. Upon confirming safe electrical compatibility, the pack manager 1110 recognizes the presence of the generic EV pack 1120 and initiates a controlled characterization routine in which the pack manager 1110 conducts a full or partial charge-discharge cycle under power-limited conditions. This characterization allows the battery energy storage system 200 to establish accurate baselines for capacity, internal resistance, energy throughput, thermal behavior, and other state-of-health indicators specific to the generic EV pack 1120. The resulting data is stored by the site controller and used to configure individualized operational parameters for the generic EV pack 1120, enabling immediate and optimized participation in the shared DC bus.

Moreover, because each battery pack is controlled separately, the battery energy storage system 200 can utilize a tailored charge/discharge profile for the generic EV pack 1120 (e.g., optimized for use and longevity). For example, because every battery pack is interfaced through a pack manager with its own isolated DC/DC converter and control processor, the battery energy storage system 200 can independently regulate current limits, voltage ceilings, thermal thresholds, and charge-rate profiles according to the measured state-of-health, temperature behavior, internal resistance, and degradation level of the corresponding pack. These tailored profiles allow the battery energy storage system 200 to cause healthier or higher-capacity packs to contribute proportionally greater power, while causing more aged or thermally sensitive packs operate at reduced stress levels to slow degradation. The battery energy storage system 200 also utilizes this per-pack optimization to enable asymmetric behavior (e.g., charging one pack more aggressively while lightly cycling another), without destabilizing the system DC bus.

In one or more embodiments, the pack manager 1110 is configured to support either a 12V or 24V BMS, or alternatively, it can accommodate both voltage supplies, which are installed and routed to the battery pack. In some cases, the pack manager 1110 performs an advanced auto-detection method that utilizes CAN data to identify the specific battery pack type. The pack manager 1110 integrates both 12V and 24V power supplies and dynamically routes the appropriate voltage to the generic EV pack 1120 via pack-specific control cables. Additionally, the pack manager 1110 performs serial number identification through one of two methods: (1) associating a unique identifier from the BMS 1122, if available, with a proprietary serial number for system tracking, or (2) encoding the serial number directly into a control cable that remains permanently paired with the battery pack to ensure system integrity and traceability. In this way, the pack manager 1110 facilitates robust compatibility, safety, and operational efficiency in field-interchangeable battery systems.

In one or more embodiments, the pack manager 1110 receives high-voltage (HV) battery output from the generic EV pack 1120 and processes the HV output, aligns the pack voltage to the system DC bus 1130, and enforces pack-specific limits. In this way, the pack manager 1110 enables the generic EV pack 1120 to source or sink power on a common DC bus without requiring the generic EV pack 1120 to match the voltage, chemistry, degradation level, or communication protocol of other disparate battery packs. Moreover, the pack manager 1110 exchanges telemetry and protective signals with the BMS 1122 of the generic EV pack 1120 and translates the information into normalized status data for upstream devices.

For example, the pack manager 1110 enables the battery energy storage system 200 to charge the generic EV pack 1120 safely and efficiently (without requiring uniform chemistry, capacity, age, or manufacturer origin). To illustrate, the battery energy storage system 200 receives electrical energy from one or more energy generation subsystems, such as solar photovoltaic (PV) arrays, wind turbines, or other variable-output renewable sources. Because the generic EV pack 1120 may originate from various manufacturers and may exemplify different stages-of-life, varying states-of-health, internal resistances, degradation levels, charge-rate limitations, and thermal sensitivities, the generic EV pack 1120 requires a targeted charging profile. The battery energy storage system 200 utilizes the pack manager 1110 to dynamically allocate charging energy to the generic EV pack 1120 according to pack-specific characteristics.

Similarly, in one or more embodiments, the pack manager 1110 enables the battery energy storage system 200 to discharge the generic EV pack 1120 safely and efficiently (without requiring a uniform chemistry, capacity, age, or manufacturer origin). For example, the battery energy storage system 200 utilizes the pack manager 1110 to prioritize power contributions from battery packs that demonstrate higher state-of-health, greater available capacity, or more favorable degradation characteristics, as reported by the corresponding battery management systems. Utilizing the pack manager 1110, the battery energy storage system 200 ensures the functionality of the generic EV pack 1120 remains within a safe operating window. For example, the battery energy storage system 200 utilizes the pack manager 1110 to adapt energy distribution from the generic EV pack 1120 based on manufacturer-specific performance characteristics for the generic EV pack 1120 (e.g., assigning a larger portion of system charge or discharge current to healthier packs while proportionally reducing the current allocated to more degraded packs to minimize further wear).

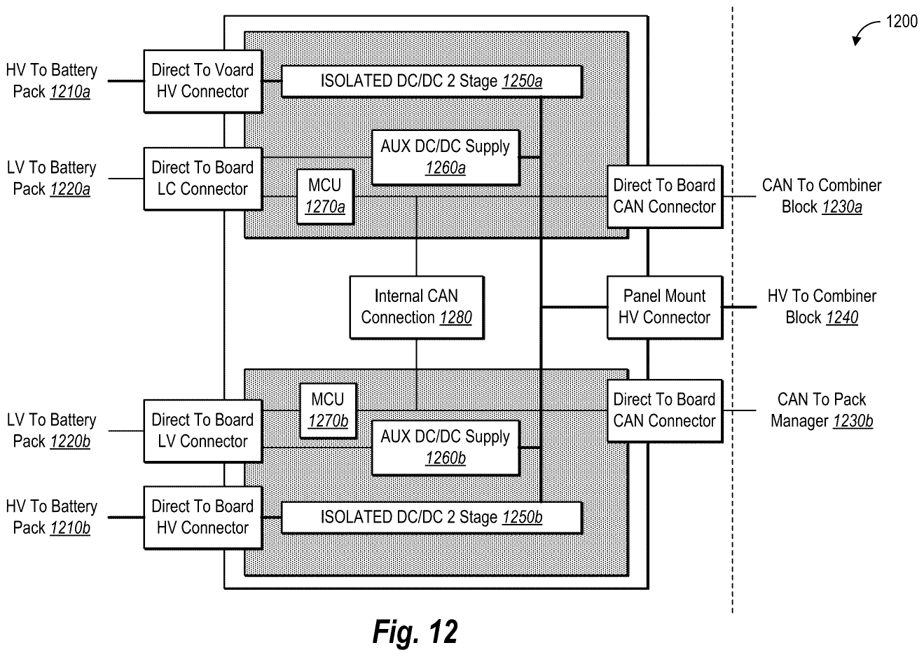

As mentioned, in one or more embodiments, the battery energy storage system 200 configures the pack managers to regulate, protect, and integrate disparate battery packs with a system DC bus. FIG. 12 illustrates an example configuration for a pack manager within the battery energy storage system 200 in accordance with one or more embodiments.

As shown in FIG. 12, the pack manager 1200 can be configured to interface with and manage disparate battery packs within the battery energy storage system 200. As shown, the pack manager 1200 includes multiple external electrical and communication interfaces. In particular, the pack manager 1200 includes a HV connection 1210a (e.g., a high voltage connection) and a LV connection 1220a (e.g., a low voltage connection) to a battery pack. As also shown, the pack manager 1200 includes a HV connection 1210b and a LV connection 1220b to a battery pack. Moreover, the pack manager 1200 includes a CAN communication link 1230a to a combiner block and a CAN communication link 1230b to an adjacent pack manager. The pack manager 1200 further includes a HV output 1240 to the combiner block.

The battery energy storage system 200 can utilize the pack manager 1200 of FIG. 12 to manage two battery packs. As illustrated, the pack manager 1200 includes two sections that enable parallel processing and power conversion. In addition, the pack manager 1200 includes an internal CAN connection 1280 to coordinate current sharing and exchange data between the two sections. To illustrate, the pack manager 1200 can dedicate a parallel processing and power-conversion section to each of the battery packs. The pack manager 1200 utilizes an isolated DC/DC converter 1250a, an auxiliary DC/DC supply 1260a, and a microcontroller unit (MCU 1270a) to provide power conversion, pack control, and BMS communication for the first battery pack. Similarly, the pack manager 1200 utilizes an isolated DC/DC converter 1250b, an auxiliary DC/DC supply 1260b, and a MCU 1270b to manage the second battery pack.

In one or more embodiments, the battery energy storage system 200 utilizes the pack manager 1200 to manage a single battery pack. To illustrate, the pack manager 1200 connects the HV connection 1210a, the LV connection 1220a, the HV connection 1210b, and the LV connection 1220b to a single battery pack. In this way, the pack manager 1200 can increase the maximum usable power draw from a single battery pack by combining the current-handling capability of the isolated DC/DC converter 1250a and the isolated DC/DC converter 1250b (e.g., the converters share the load proportionally). Moreover, by distributing the conversion workload across the isolated DC/DC converter 1250a and the isolated DC/DC converter 1250b the pack manager 1200 can reduce localized heating and enhance thermal performance.

As illustrated in FIG. 12, the pack manager 1200 utilizes the auxiliary DC/DC supply 1260a and the auxiliary DC/DC supply 1260b to provide low-voltage power for control, sensing, and communication functions associated with each battery pack. The pack manager 1200 utilizes the auxiliary DC/DC supply 1260a and the auxiliary DC/DC supply 1260b to convert the high-voltage input from the battery pack or shared DC bus into a stable, isolated low-voltage output suitable for powering the battery pack microcontroller, contactor-driver circuitry, voltage and temperature sensing electronics, communication transceivers, and other safety-critical subsystems.

Moreover, because the battery packs of the battery energy storage system 200 originate from different manufacturers and a have different capabilities, their electrical behavior may differ substantially. The pack manager 1200 utilizes galvanic isolation provided by the isolated DC/DC converter 1250a and the isolated DC/DC converter 1250b to mitigate risks associated with connecting such disparate battery packs in parallel or to a shared system DC bus by preventing direct conductive paths from the battery packs. In this way, the pack manager 1200 protects against fault propagation, such as high-current fault events, ground faults, or voltage excursions that may arise due to differences in manufacturer design or degradation levels. In one or more embodiments, the pack manager 1200 utilizes isolated DC/DC converters with an operating power of approximately 20 KW (or two-stage 10 kW modules) capable of processing up to 31 A at 1300-1450 V on the DC bus and 67 A at 250-900 V on the battery interface.

Furthermore, the pack manager 1200 incorporates isolated auxiliary DC/DC supplies for each battery pack to ensure proper electrical separation and independent operation. During startup, the pack manager 1200 utilizes the auxiliary DC/DC supply 1260a and the auxiliary DC/DC supply 1260b to employ the monitoring and protection circuitry needed to perform pre-charge verification, safety checks, and BMS communication before enabling the DC/DC power-conversion. During shutdown or fault isolation, pack manager 1200 utilizes the auxiliary DC/DC supply 1260a and the auxiliary DC/DC supply 1260b to maintain sufficient low-voltage power to allow the pack manager 1200 to open contactors, record diagnostic information, and complete a controlled transition to a safe state.

In addition, the pack manager 1200 utilizes the MCU 1270a and the MCU 1270b to manage contactor control, cell-parameter monitoring, thermal safety, and state-of-charge reporting. For example, the pack manager 1200 utilizes the MCU 1270a and the MCU 1270b to exchange data with the battery pack BMS to obtain cell voltages, pack currents, temperatures, state-of-charge, and state-of-health metrics. Moreover, the pack manager 1200 can utilize the MCU 1270a and the MCU 1270b to issue control signals to actuate contactors, initiate pre-charge routines, request pack-level derating, implement droop-based current regulation, implement safety interlocks, implement temperature protections, and initiate controlled shutdown sequences. In some embodiments, the pack manager 1200 utilizes the MCU 1270a and the MCU 1270b to communicate over the internal CAN connection 1280 to coordinate balancing behavior between the battery packs and aggregate telemetry data for upstream reporting.

As mentioned, the pack managers can utilize CAN (or a similar communication protocol) to communicate. In one or more embodiments, the pack manager 1200 includes the CAN communication link 1230a to communicate with a combiner block. Moreover, the pack manager 1200 includes a CAN communication link 1230b to communicate with an additional pack manage and the internal CAN connection 1280 to communicate between internal sections. Using the CAN connections illustrated in FIG. 12, the battery energy storage system 200 can daisy chain multiple pack managers, thereby enabling the pack managers to exchange status information, operational data, and control signals over a shared bus with minimal cabling. In this way, the pack manager provides a compact and efficient communication architecture for coordinating communication between the pack managers of an inverter block.

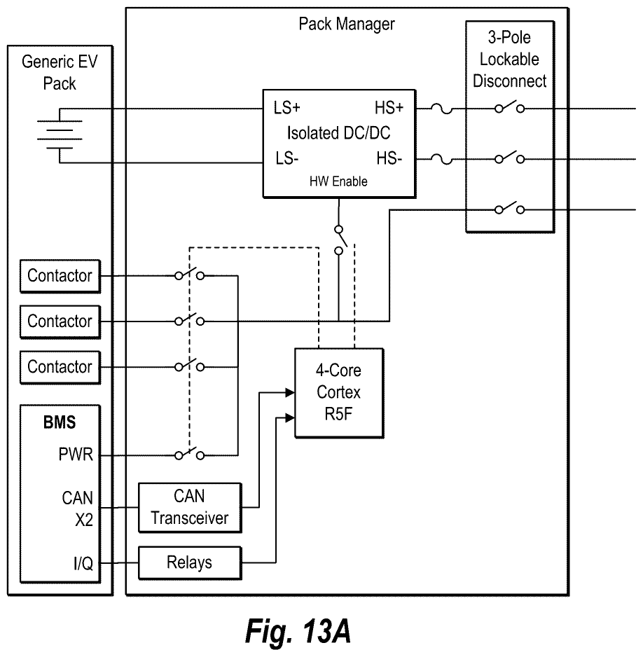

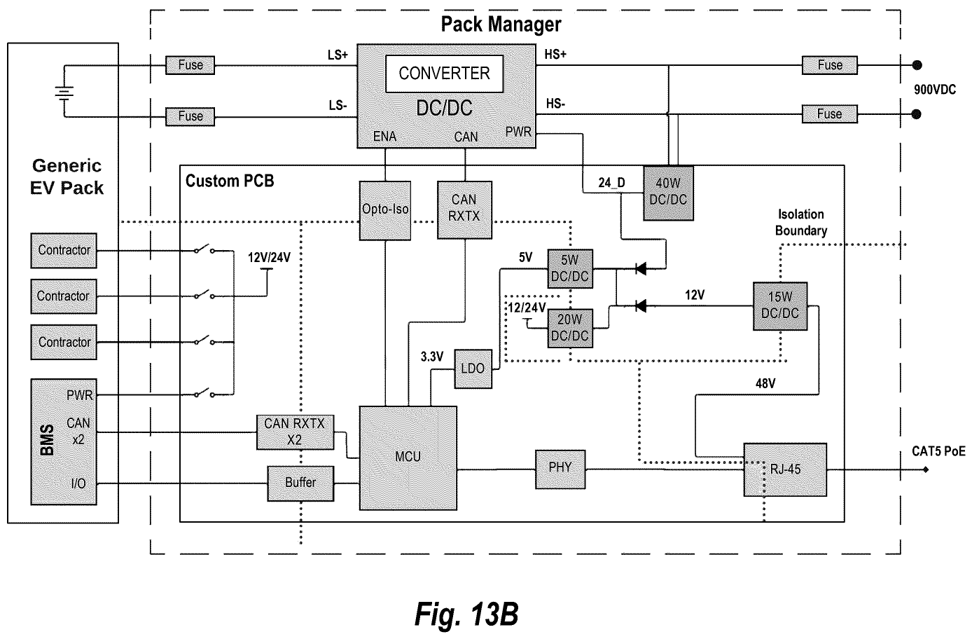

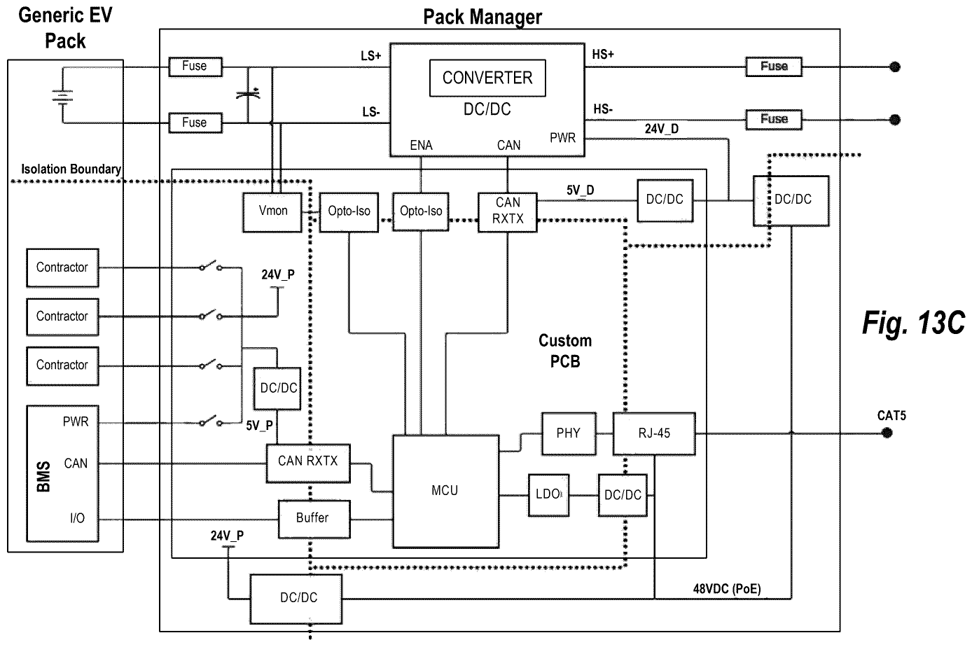

As mentioned, the battery energy storage system 200 can utilize additional configurations for the pack managers that manage the disparate battery packs. FIGS. 13A-13C illustrate additional example configurations for pack managers within the battery energy storage system 200 in accordance with one or more embodiments.

FIGS. 13A-13C illustrate three alternative physical implementations of a pack manager within the battery energy storage system 200, each providing a similar functional interface. As illustrated, the battery energy storage system 200 can employ pack managers as a compact, single battery pack control units that provides both the electrical interface and the communication pathway between an individual battery pack and the system DC bus. As illustrated, the pack manager conditions the battery-specific voltage to the standardized system DC bus voltage, supplies low-voltage power for sensing and control electronics, and exchanges operational data with the battery pack BMS to maintain operation within a defined safe state. The battery pack control subsystem monitors cell and pack parameters, executes protection logic, and adjusts current flow in accordance with system-level power commands and droop-control behavior. Through this combination of power conversion, low-voltage control, and communication functions, the pack managers enable disparate second-life battery packs to operate within the distributed DC-bus architecture.

As illustrated in FIGS. 13A-13C the battery energy storage system 200 utilizes pack managers that are versatile, environmentally robust, and employ user-friendly components for managing the battery packs. The pack managers interface with the BMS of EV battery packs by transmitting and receiving electrical signals. Indeed, the pack managers are configured to be connected to the signal wiring of a battery pack, such as an electric vehicle (EV) battery pack. The pack managers may include an embedded processor or a non-transitory computer-readable medium programmed with algorithms that interpret BMS signals and provide corresponding responses to ensure safe operation of the battery packs.

For example, the pack managers are designed for scalability and efficient energy management. The pack managers manage pack charge and discharge control through DC/DC mechanisms and powers the Battery Management System (BMS) with typical voltage requirements of 12 or 24 VDC. The pack managers support bidirectional BMS communications to ensure efficient data exchange. Additionally, the pack managers drive pack contactor coils and performs computations for state-of-charge (SoC), state-of-Health (SoH), and fault detection. Finally, the pack managers incorporate Ethernet communications to facilitate network connectivity and data sharing.

As noted, the pack managers distinguish between battery pack types. For example, the pack managers allow for distinguishing battery pack types using Controller Area Network (CAN) data. In some embodiments, to ensure reliable operation, the pack managers utilize a verification mechanism during the power-on sequence of the BMS to perform a sanity check to confirm that the detected configuration aligns with the expected configuration based on CAN data. Additionally, CAN data may include serial numbers and other identifying information, which the pack managers can utilize to detect if battery packs of the same type have been swapped or if cabling has been altered between connections. While this capability may not be universally supported across all battery pack types, the pack managers are designed to leverage such information when available to enhance diagnostic precision. An alternative approach involving adapter cables with unique identifiers, such as an ID EEPROM, can be used by the battery energy storage system 200 to provide more accurate differentiation of battery pack types. This combination of CAN-based diagnostics and optional adapter cable identification represents a flexible solution for managing compatibility and configuration for the battery packs.

The algorithms embedded in the pack managers may facilitate dynamic load adjustments to the battery pack, monitor resulting voltage changes in individual cells or modules, and compute deviations and response times. For example, the pack managers may apply dynamic load adjustments to a battery pack by varying charge or discharge current to evaluate electrical response characteristics of the battery pack. In turn, the pack managers may compute voltage deviation metrics based on differences between the expected voltage values and the measure voltage values. These functions can be executed repeatedly across multiple charge and discharge cycles to detect patterns of degradation. Upon identifying an unacceptable degradation rate (quantified by thresholds for voltage variation, deviations, or response times), the pack managers may transmit control signals to the BMS to halt, rest, or limit the usage of specific cells, modules, or the entire battery. Furthermore, the pack managers can execute predetermined operational modes, including but not limited to, safe startup, shutdown, standby, charging, and discharging.

The pack managers may also be configured to gather data from the BMS and present it via a graphical user interface (GUI). This GUI enables users to view detailed insights regarding battery status and health, such as voltage levels, current output, state-of-charge, state-of-health, and operational time. Additionally, the GUI may accept user input for queries or mode configurations, allowing the system to be adjusted for specific operations.

The pack managers may further support compatibility with various EV battery types from multiple manufacturers. To achieve this, the pack managers may download specific operational procedures or algorithms tailored to the requirements of the connected battery. This capability ensures seamless integration and facilitates the use of the pack managers across a wide range of EV battery systems without requiring uniform chemistry or identical cell specifications.

In certain implementations, the pack managers include pack-to-bus interface logic configured to coordinate the electrical and communication pathways between the battery pack, the isolated DC/DC converter, and the system DC bus. This interface logic may include measurement circuits for monitoring pack voltage, pack current, and DC-bus voltage, as well as control lines for managing pre-charge resistors, discharge paths, and high-voltage contactors. The interface logic ensures that power transfer only occurs when both the battery pack and the DC bus satisfy predefined safety and compatibility conditions, including appropriate voltage alignment, temperature limits, and BMS approval states. The logic may further debounce fault signals, verify communication integrity, and manage the timing of transitions between charge, discharge, idle, and isolated states. By coordinating the handoff between low-voltage control functions and high-voltage power transfer, the pack-to-bus interface logic provides a reliable and predictable mechanism for integrating heterogeneous second-life battery packs into the system DC bus.

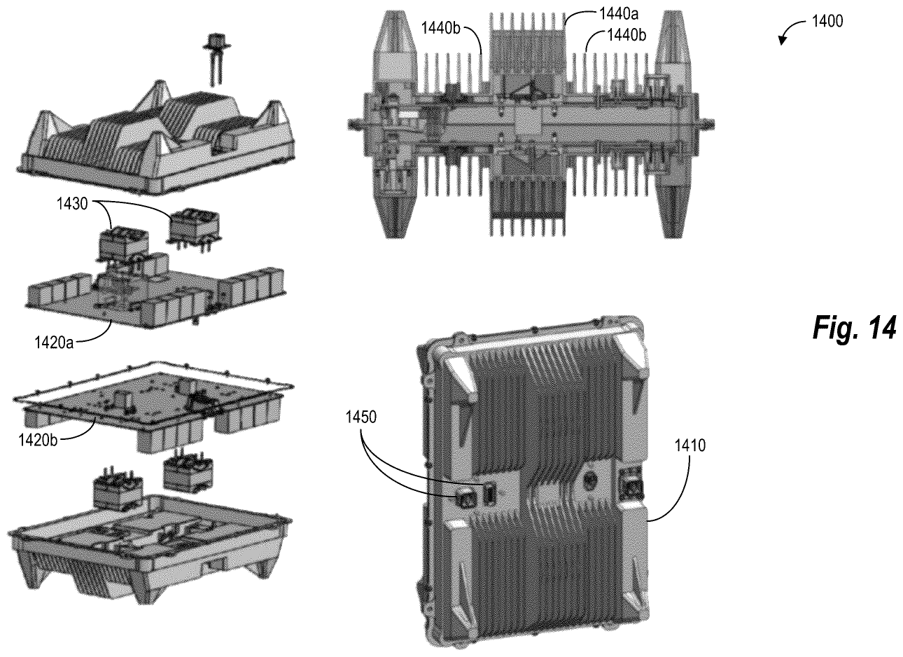

As mentioned, the battery energy storage system 200 utilizes pack managers that are designed to withstand diverse environmental conditions. FIG. 14 illustrates an example physical design for a pack manager of the battery energy storage system in accordance with one or more embodiments.

As illustrated in FIG. 14, the battery energy storage system 200 incorporates pack managers with a robust physical design intended to operate outdoors continuously throughout all seasons, day and night. For example, the pack manager assembly 1400 incorporates structural and environmental features engineered for outdoor deployment and high-power density and that enhance field reliability and simplify maintenance. In one or more embodiments, the pack manager assembly 1400 achieves an exemplary gravimetric energy-handling density of approximately 0.80 kW/kg, enabling a 40 kW unit at a mass of roughly 50 kg, and an exemplary volumetric energy-handling density of approximately 0.39 kW/L, corresponding to a similar power rating at a volume of about 102 liters.

As illustrated, the pack manager assembly 1400 is enclosed within a sealed casing 1410 designed to withstand dust, moisture, and rainfall typical of outdoor installations while enabling the device to operate across a wide ambient temperature range. Moreover, the internal electronics include two board assemblies 1420a and 1420b, which support the power-conversion stages, microcontroller units, and safety-critical circuitry required to interface with disparate battery packs. The internal and external interfaces for the pack manager assembly 1400 (such as high-voltage connections, low-voltage auxiliary connections, and CAN communication links), terminate through board-mounted connectors 1430 and external connectors 1450, ensuring robust mechanical retention, simplified field wiring, and reduced susceptibility to vibration or handling stress.

As also illustrated, the pack manager assembly 1400 includes extruded fins 1440a and extruded fins 1440b along the exterior surface of the sealed casing 1410. In some embodiments, the extruded fins 1440a are formed along a first surface of the sealed casing 1410 and the extruded fins 1440b are formed along a second raised surface of the sealed casing 1410. The battery energy storage system 200 can utilize the extruded fins 1440a and the extruded fins 1440b to promote efficient passive convection cooling for the pack manager assembly 1400 while under continuous load. For example, the configuration of the extruded fins 1440a and extruded fins 1440b, allows the pack manager assembly 1400 to dissipate heat from the internal DC/DC converters through natural convection. In one or more embodiments, the extruded fins 1440a and the extruded fins 1440b may be dimensioned to provide effective thermal derating behavior under elevated ambient temperatures, allowing the pack manager assembly 1400 to continue operating at reduced load rather than shutting down during heat events. Moreover, the extruded fins 1440a and the extruded fins 1440b may be scaled or resized for different thermal loads while maintaining a consistent mounting footprint for interoperability across sites.

For the illustrated hardware design, the pack manager assembly 1400 can function at ambient temperatures between −20 and 50 degrees Celsius, even at a 3000-meter elevation. For altitude adaptability, the pack manager assembly 1400 includes a pressure equalization valve to mitigate damage or ingress due to atmospheric changes and ensures all internal components are resistant to large variations in elevation. In some embodiments, the pack manager assembly 1400 incorporates mechanical isolation mounts, strain-relief features, and reinforced connector housings to improve survivability under outdoor vibration, seismic loading, and handling stresses. The pack manager assembly 1400 can withstand abrupt humidity changes, resist heavy rainfall, and are designed for outdoor use under Pollution Degree 4 standards. The lifetime and pollution resistance of the pack manager assembly 1400 adds to the performance and reliability.

In one or more embodiments, the pack manager assembly 1400 is configurable to various mechanical specifications. For example, in one or more implementations the pack manager assembly 1400 dimensions are limited to a volume smaller than carry-on luggage, with a weight of approximately 50 lbs., allowing for single-person portability as per OSHA guidelines. The pack manager assembly 1400 meets IP66/NEMA 4 ingress-protection ratings, enabling outdoor deployment in harsh conditions without ingress of dust or water, and implements IPXXB touch safety to ensure that no live parts are accessible during operation or service. The mechanical architecture and grounding layout satisfy UL 1741, UL 1973, and FCC Part A requirements, demonstrating compliance with both electrical safety and electromagnetic-emission standards.

Effective thermal management ensures the pack manager assembly 1400 rejects heat generated by the DC/DC converter under maximum load during peak environmental conditions without exceeding temperature thresholds. In one or more embodiments, the pack manager assembly 1400 is able to lay stably on the ground without additional mounting and are designed with integrated mounting features to keep the pack manager assembly 1400 elevated above pooled surface water by 3-4 inches. In one or more embodiments, the pack manager assembly 1400 includes portability features including a removable lid or panel for field servicing, accessible and replaceable fuses, and integrated handles for manual lifting and transport. Together, these features support robust outdoor deployment while allowing the pack manager assembly 1400 to be installed, replaced, or upgraded in the field with minimal system disruption.

In one or more embodiments, the pack manager assembly 1400 features intuitive operator interfaces. For example, the pack manager assembly 1400 includes a visible LED that indicates critical statuses, including system power, battery pack voltage, active BMS communication, and fault states. In one or more embodiments, this LED is visible from at least 3 meters. In one or more embodiments, an audible alarm activates under software-defined fault conditions. The pack manager assembly 1400, in one or more embodiments, includes an external enable toggle switch for controlling the DC/DC converter operation, which is not intended as a safety lockout.

In one or more embodiments, the pack manager assembly 1400 incorporates user-friendly, secure, and tool-free cable connections for the external connectors 1450. For example, in one or more embodiments, the pack manager assembly 1400 includes High-voltage (HV) connectors that are designed with locking, latching, and keyed mechanisms to prevent incorrect connections. Moreover, the external connectors 1450 may include keyed high-voltage couplers, locking low-voltage signal connectors, and environmental gaskets to maintain ingress protection during operation and service. Additionally, in one or more embodiments, the external connectors 1450 include outdoor-rated connectors that support BMS, contactors, RJ-45 Cat6 communication cables, and system power.

In one or more embodiments, the pack manager assembly 1400 includes the sealed casing 1410 that is electrically isolated from internal conductors and securely connected to the battery chassis with low resistance. In one or more embodiments, the pack manager assembly 1400 includes high-voltage disconnect switches that allow manual disconnection for safe battery hot-swapping. In one or more embodiments, the pack manager assembly 1400 supports dual system power options: the primary 900 V DC bus for full functionality and PoE for basic operations such as communications. As mentioned, the pack manager assembly 1400 supports software for the pack managers to monitor and report power supply mode to the system host. Additionally, in one or more embodiments, pack manager assembly 1400 supports multiple contactor coil control channels and provide robust galvanic isolation between key subsystems.

In one or more embodiments, the pack manager assembly 1400 deliver precise current and voltage control with ±2% accuracy and swift transient response. In one or more embodiments, the pack manager assembly 1400 includes protection mechanisms including manual safety disconnect switches and fuses on the system DC bus. In one or more embodiments, the pack manager assembly 1400 features a robust network interface, including an RJ-45 connector and Cat5 cable, supporting communication at 100 Mbps to ensure reliable and fast data transmission.

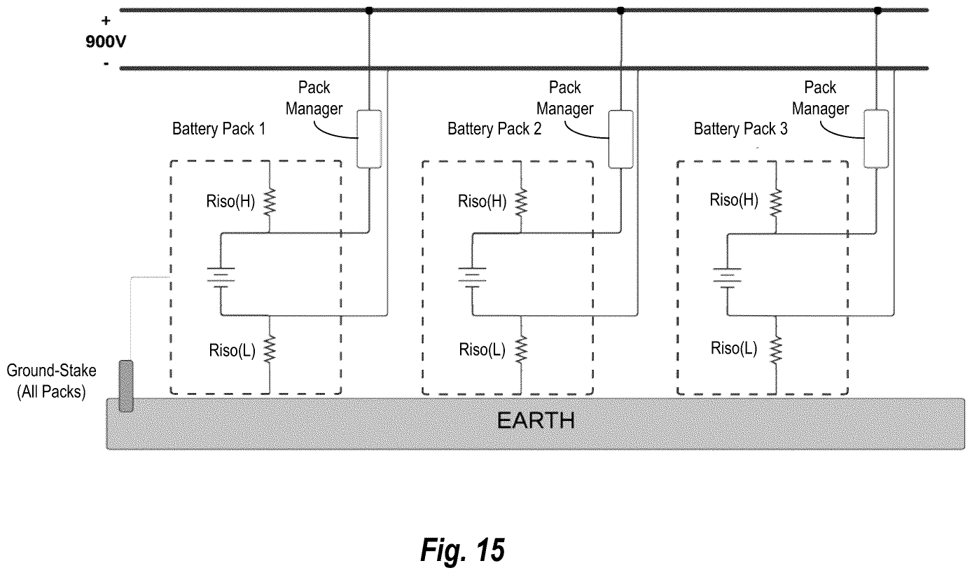

As mentioned, the battery energy storage system 200 manages disparate battery packs across a heterogeneous outdoor system. In one or more embodiments, the battery energy storage system 200 employs the pack managers to monitor localized fault isolation for the disparate battery packs by capitalizing on the distributed outdoor structure of the battery energy storage system 200. FIG. 15 is a diagram illustrating pack managers performing battery pack isolation and monitoring in accordance with one or more embodiments.

As illustrated in FIG. 15, in one or more embodiments, the battery energy storage system 200 incorporates localized fault isolation methods for individual battery packs. For example, the battery energy storage system 200 employs localized grounding strategies to keep each battery pack electrically self-contained such that a fault in one battery pack does not propagate across the battery energy storage system 200. Because each of the battery packs has its own ground (e.g., ground stake, ground rod), the pack managers can isolate the battery packs with a ground-fault imbalance or an abnormal chassis voltage. Furthermore, because the pack managers are electrically coupled to only one or two battery packs, the pack managers have direct access to confine a fault to a specific pack without disturbing the rest of the system.

In some embodiments, each pack manager continuously monitors the chassis-to-ground voltage, leakage current, insulation resistance, and HV line current imbalance for the associated battery pack(s). The pack managers can identify fault conditions such as a conductor contacting the enclosure, moisture-driven leakage paths, insulation breakdown, or abnormal drift in pack-to-ground potential. When a fault condition occurs, the associated pack manager acts autonomously to isolate the affected battery pack by opening the battery pack contactors, disabling the isolated DC/DC converter stage, and preventing any further power flow from the battery pack across the high-voltage interface. Because the pack manager enforces the battery pack isolation locally, the remaining pack managers maintain normal operation, and the system DC bus remains stable (via droop-controlled power sharing).

In one or more embodiments, the pack manager also reports detailed fault diagnostic data upstream (such as ground-fault magnitude, cell voltages at the moment of isolation, and insulation resistance trends). Based on the fault diagnostic data, the inverter block controller and/or the site controller log events, verify that battery pack isolation succeeded, and redistribute power commands for the remaining healthy battery packs. In this way, the pack managers protect the battery energy storage system 200 from cascading failures and enable continuous operation even when individual battery packs exhibit detrimental behavior.

In one or more embodiments, the battery energy storage system 200 incorporates predictive-health monitoring capabilities that enable early identification of battery pack degradation, abnormal behavior, or potential thermal events before they manifest as active faults. Using continuous telemetry from each battery pack (including voltage transients, current response under controlled load pulses, temperature gradients, internal resistance trends, and state-of-health estimates), the pack managers analyze deviations from expected behavior to detect emerging failure patterns. Using this real-time assessment the battery energy storage system 200, identifies conditions such as accelerated aging, weakened cells, diminishing capacity, or abnormal thermal signatures that often precede end-of-life events. By detecting these indicators early, the battery energy storage system 200 can proactively adjust charging limits, reduce current contribution, schedule health checks, or isolate vulnerable packs, thereby reducing the likelihood of catastrophic failure and maintaining increases battery pack safety and extends the useful life of the disparate second-life battery packs.

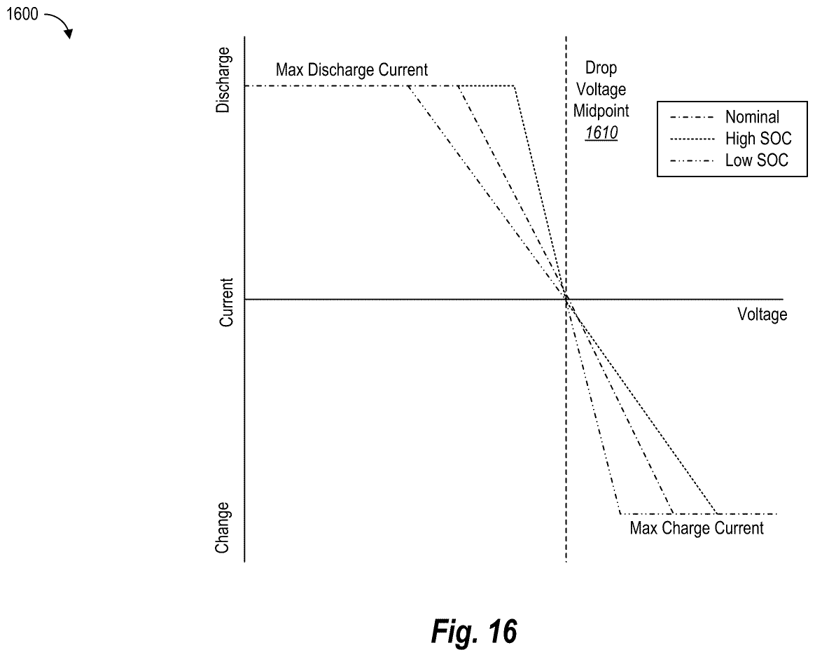

As mentioned, in one or more embodiments, the battery energy storage system 200 manages battery pack power balance with the pack managers utilizing DC droop control. FIG. 16 illustrates an example DC droop curve used by the battery energy storage system 200 to regulate the charge and discharge current of a battery pack using a pack manager in accordance with one or more embodiments.

FIG. 16 illustrates an example DC droop curve used by the battery energy storage system 200 to coordinate operation among pack managers connected to a common system DC bus. For example, when employed across large numbers of disparate battery packs, the battery energy storage system 200 utilizes DC droop control to ensure that the DC bus remains stable during fast transients by distributing power according to battery pack capability. Using DC droop control, the battery energy storage system 200 enables a large number of battery packs (e.g., in some cases between approximately ninety-six and two-hundred-forty battery packs), to behave as a single software-defined battery from the perspective of one or more inverters.

In one or more embodiments, the pack managers utilize DC droop curves determine when to instantaneously source power to or absorb power from the DC bus in response to inverter transients. In this way, the battery energy storage system 200 utilizes the DC droop curves to operate the pack managers as voltage-controlled current sources configured to adjust output current based on deviations of the DC bus voltage from a nominal reference voltage. The slope of the DC droop curve implemented by each pack manager is determined as a function of the state-of-energy of the corresponding battery pack, thereby providing a distributed energy-balancing mechanism across the plurality of battery packs.

As illustrated in FIG. 16, the battery energy storage system 200 utilizes a DC droop curve 1600 to enable a specific pack manager to regulate the charge and discharge current for a specific battery pack. For example, the battery energy storage system 200 determines the available energy and power for the specific battery pack. Moreover, the battery energy storage system 200 determines the droop voltage midpoint 1610 and the required slope to balance the state-of-energy for the specific battery pack (utilizing the specific pack manager), while respecting the battery pack currents and power limits.

In some cases, the battery energy storage system 200 defines the DC droop curve utilizing droop parameters that compensate for the differences between the disparate battery packs. For example, the battery energy storage system 200 utilizes the droop parameters to establish an equilibrium point, neutral operating region, slope of current response, and current limits for each battery pack. The battery energy storage system 200 defines droop parameters such as:

| Value | | Units |
|---|---|---|
| Droop Voltage | The target voltage of the bus, and the voltage | V |
| Midpoint | at which the DC/DC does not output either | |
| | charge or discharge current | |
| Droop | The deadband around the voltage midpoint, | V |
| Deadband | where DC/DC output is also zero | |
| Charge Slope | The change in charge current per 1 V | A/V |
| | change in bus voltage | |
| Discharge Slope | The change in discharge current per 1 V | A/V |
| | change in bus voltage | |
| Max Charge | The maximum current the pack manager | A |
| Current | should sink | |
| Max Discharge | The maximum current the pack manager | A |
| Current | should source | |

For example, the battery energy storage system 200 can utilize the droop parameters to define a droop voltage midpoint that defines the nominal DC bus voltage at which the pack manager should output zero current. When the bus voltage remains equal to the droop voltage midpoint, the pack manager neither charges nor discharges the battery pack. Moreover, the battery energy storage system 200 utilizes a droop deadband to establish a voltage range around the droop voltage midpoint within which the pack manager continues to draw zero current from the battery pack, thereby preventing oscillatory behavior and eliminating small circulating currents between multiple pack managers on the same DC bus.

Outside the droop deadband, the pack manager adjusts the battery pack current output based on a defined charge slope and discharge slope of the DC droop curve, each expressed in amperes per volt. When the bus voltage rises above the upper edge of the droop deadband, the pack manager applies the charge slope to determine a corresponding charging current to draw from the battery pack, sinking power from the DC bus. Conversely, when the bus voltage drops below the lower edge of the droop deadband, the pack manager applies the discharge slope to determine a discharging current, sourcing power to the battery pack to support the system DC bus. In this way, the battery energy storage system 200 utilizes the charge slope and the discharge slope to define how aggressively the pack manager responds to deviations in bus voltage for coordinated power sharing across the battery pack.

To protect the battery pack and associated power electronics, the battery energy storage system 200 further incorporates maximum charge current and maximum discharge current limits for the DC droop curve. Based on the maximum charge current and maximum discharge current limits, regardless of the voltage-based slope calculations, the pack manager caps charging and discharging currents for the battery pack at defined limits. The pack manager utilizes the maximum charge current to limit the highest current the battery pack is permitted to sink in high-voltage conditions and the maximum discharge current to limit the highest current the pack may source under low-voltage conditions. The battery energy storage system 200 utilizes the maximum charge current limit and the maximum discharge current limit to ensure safe operation across disparate second-life battery packs with differing chemistries, capacities, and states of health.

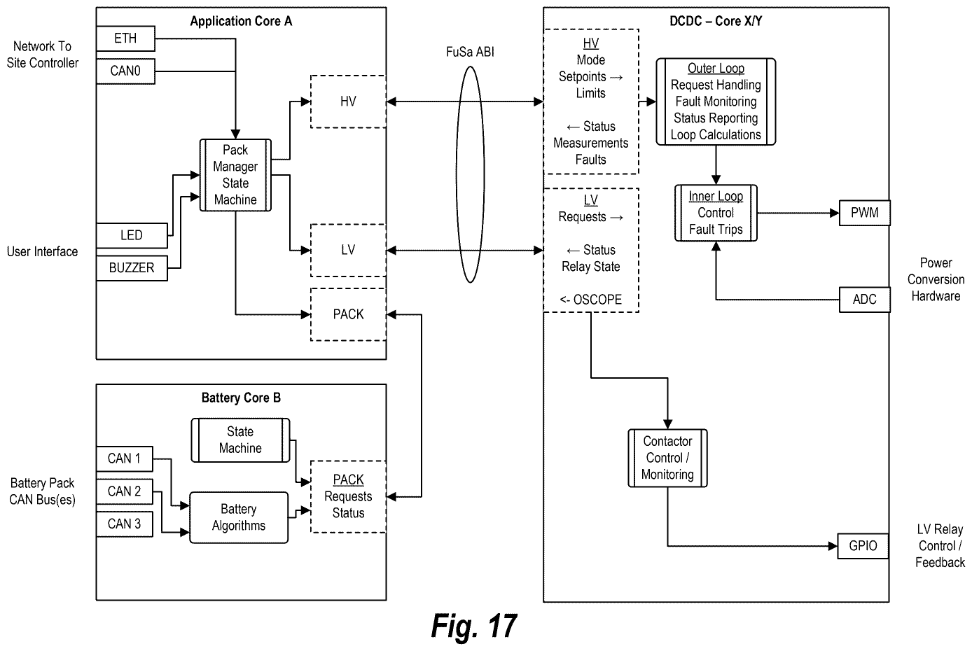

In one or more embodiments, the pack manager utilizes a multi-core software architecture to manage battery packs within the battery energy storage system 200. FIG. 17 is an example diagram of the software architecture for a pack manager in accordance with one or more embodiments.

As illustrated in FIG. 17, the battery energy storage system 200 employs a multi-core software architecture on the pack managers to manage the battery packs. In one or more embodiments, the pack managers include a multi-core software architecture that separates safety-critical functions from non-safety-critical functions utilizing a combination of safety-critical cores and non-safety-critical cores. The battery energy storage system 200 utilizes multi-core software architecture to update algorithms and external interfaces independently without jeopardizing the certified safety behavior of the core battery pack protection functions. The safety-critical cores can execute functions directly responsible for preventing unsafe operation of the battery pack, such as battery protections, real-time power-conversion control, and contactor control. The non-safety-critical cores can run higher-level algorithms such as energy and power estimation, life-prediction algorithms, logging, diagnostics, telemetry formatting, and communication with site-level systems. In some embodiments, the controller includes two safety-critical cores (e.g., DCDC-Core X/Y) and two non-safety-critical cores (e.g., Application Core A and Battery Core B), each running distinct software stacks.

In one or more embodiments, the battery energy storage system 200 utilizes the multi-core software architecture to ensure a strict isolation between the safety-critical and non-safety-critical cores. For example, the safety-critical core accesses a dedicated memory region that is not writable by non-safety-critical software. Data exchange between the safety-critical and non-safety-critical cores occurs over a defined functional safety interface. The messages passed across the defined functional safety interface includes metadata such as a sequence number or timestamp so that the receiving core can confirm that incoming data is current, even if the data values have not changed numerically. In some embodiments, the defined functional safety interface also carries a cyclic redundancy check (CRC) of the payload contents. The safety-critical cores validate the sequence or timestamp and verify the CRC before using any non-safety data. Moreover, the pack manager rejects invalid, stale, or corrupted data, and the pack manager either enters a safe state or enters a conservative operating mode.

For example, the battery energy storage system 200 utilizes safety-critical cores that enforce a variety of voltage protections for downstream battery packs. In some cases, the safety-critical cores include architecture to implement battery protections, power conversion, and contractor control. If the pack manager determines one or more of the protections corresponding to the safety-critical cores have been violated, the pack manager will go into a safe state. For example, the pack manager enforces voltage protections using the safety-critical cores including:

BATTERY PACK PROTECTIONS: Voltage Protections

Cell-level over voltage protection based on the maximum cell voltage
Cell-level undervoltage protection based on the minimum cell voltage
Pack level undervoltage protection
Pack level overvoltage protection
Missing cell voltage protection to protect against the loss of any
reported cell voltage. stuck cell voltage protection to protect
against stale voltage readings
dV/dt cell voltage protection to protect against non-physical
cell voltage readings or intermittent electrical contact in
the voltage sense chain
Sum of cell voltages mismatches pack voltage protection to
protect against ADC measurement errors

Moreover, the pack manager enforces current protections using the safety-critical cores including:

BATTERY PACK PROTECTIONS: Current Protections

Charge overcurrent protection
Discharge overcurrent protection
Short-circuit overcurrent protection

Moreover, the pack manager enforces temperature protections using the safety-critical cores including:

BATTERY PACK PROTECTIONS: Temperature Protections

Cell/module over temperature protection (threshold limit)
Cell/module under temperature protection (threshold limit)
Missing cell/module temperature protection to protect
against the loss of any reported cell voltage
Stuck cell/module temperature protection to protect
against stale voltage readings

As mentioned, in one or more embodiments, the battery energy storage system 200 utilizes a software architecture for the pack manager that includes non-safety-critical cores. The non-safety-critical cores can include architecture to implement higher-level algorithms such as energy and power estimation, life-prediction algorithms, logging, diagnostics, telemetry formatting, and communication with site-level systems. For example, the battery energy storage system 200 utilizes non-safety-critical cores to enforce battery pack current limits. For example, the pack manager shall enforce battery pack current limits including:

BATTERY ALGORITHMS: Battery Pack Current Limits

Respect the charge and discharge power limits of each battery pack
reported over CAN (if the battery pack BMS reports such limits)
Apply a thermal derating based on the maximum cell temperature in
the battery pack (e.g., available current linearly reduced to
zero between the full power operation temperature)
Limit and the maximum operation temperature limit (e.g., lower
of any pack-specific or firmware limits and 50° C. and 55° C.)
Prevent charge current of a pack above 100% operational state-of-charge
Prevent discharge current of a pack below 0% operational state-of-charge
Limit charge current to regulate the maximum cell voltage to
the maximum cell voltage limit threshold (e.g., lower of any
pack-specific limit and 4.15 V)
Limit charge current to regulate the minimum cell voltage to
the minimum cell voltage limit threshold (e.g., lower of any
pack-specific limit and 2.7 V)

Moreover, the battery energy storage system 200 utilizes the non-safety-critical cores to provide energy and power estimation. For example, the pack manager provides energy and power estimation including:

BATTERY ALGORITHMS: Energy and Power Estimation

Estimate state-of-charge shall for each parallel cell group in
each battery pack (e.g., using a Kalman filter approach, using
the temperatures, voltages, and currents measured by the OEM BMS)
Calculate a pack-level state-of-charge (e.g., based on a
simulation of when each cell group will hit an end-of-
discharge termination point)
Estimate cyclic capacity for each cell group in each battery
pack (e.g., based on coulomb counting between rested OCV lookups)
Produce a pack-level energy remaining value (e.g., combine
cyclic capacity with the state-of-charge estimate)
Calculate a power available representing the charge and
discharge power the pack manager can sustain for the
next 60 seconds

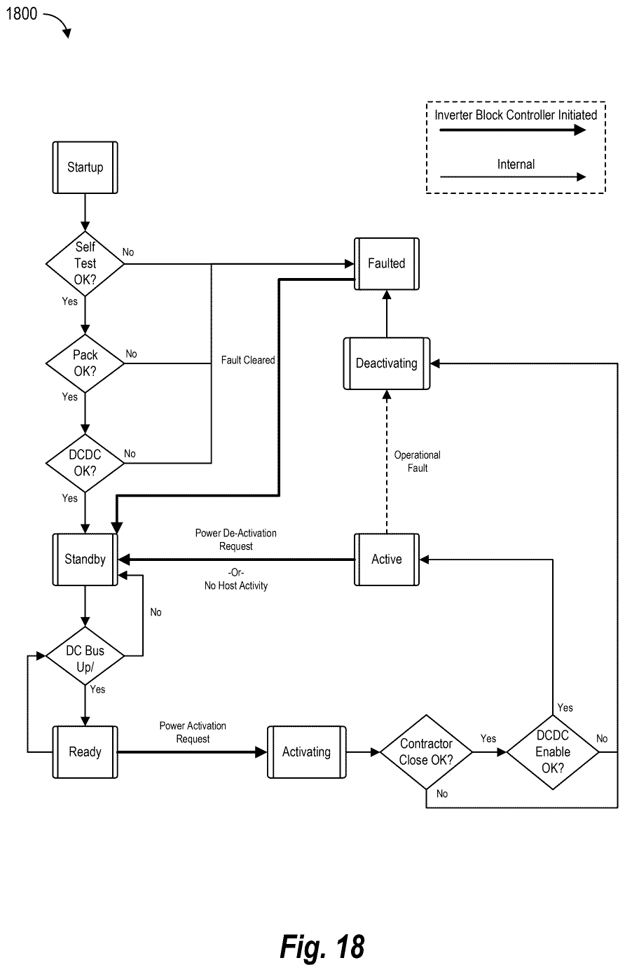

In one or more embodiments, the battery energy storage system 200 includes one or more state machines to govern the operation of the pack manager to cause the battery pack to transition between operational modes such as startup, standby, active, and faulted. FIG. 18 illustrates an example state machine representing the operation of a pack manager in accordance with one or more embodiments.

As illustrated in FIG. 18, in one or more embodiments, the battery energy storage system 200 operates the pack managers according to a state machine 1800 that governs the safe and balanced control of a corresponding battery pack. For example, the state machine 1800 governs remote alerting, monitoring, and per-pack operational control to support safe, prolonged use of degraded or aging battery packs. Because each battery pack is individually managed by its own isolated pack manager, the battery energy storage system 200 can closely regulate reduced-capability packs rather than removing entire strings or blocks from service. The pack manager communicates detailed pack-health metrics to the site controller, which may automatically issue remote alerts when indicators exceed predefined thresholds, including temperature rise rates, state-of-health declines, or voltage-imbalance conditions (or when maintenance is required). In response, the battery energy storage system 200 may continue operating the affected battery pack at a derated capability or restrict the affected battery pack to limited charge/discharge modes, enabling continued utilization rather than full replacement of the battery pack. This approach reduces waste, minimizes downtime, and enables distributed maintenance without shutting down healthy battery packs.

For example, the state machine 1800 governs how a pack manager manages the safe and balanced control of a battery pack between predefined operational modes such as startup, standby, active, activating, ready, faulted, and deactivating. Each state of the state machine 1800 defines the permissible actions of the power-conversion hardware and contactors, the required safety checks, and the conditions under which the battery pack may participate in system-level power flow.

As illustrated in FIG. 18, the battery energy storage system 200 initializes the pack manager in a Startup state upon application of auxiliary power or after a reset event. During the Startup state, the pack manager executes a power-on self-test (POST) that validates processor integrity, confirms functional safety isolation, and checks basic hardware readiness including DC/DC converters, contactor-driver circuits, and isolation sensors. The battery energy storage system 200 maintains the pack manager in the Startup state until all initialization checks pass. If any mandatory check fails, the battery energy storage system 200 transitions the pack manager to the Fault state.

Moreover, upon successful completion of the Standy state, the battery energy storage system 200 transitions the pack manager to a Standby state. In the Standby state, the pack manager maintains the battery pack as electrically isolated from the DC bus (e.g., with the pack contactors open and the DC/DC power stage inactive). In the Standby state, the pack manager monitors battery telemetry such as voltage, cell balance, temperature, and state-of-charge, while awaiting authorization or command signals from the inverter block controller.

In some embodiments, the state machine 1800 includes a Ready state that represents an intermediate operational mode between the Standby state and an Active state. After completing initialization and entering the Standby state, the pack manager transitions into the Ready state once all non-critical preconditions for activation are met. As shown, these preconditions may include confirming stable communication the system DC bus. In the Ready state, the pack manager remains electrically isolated from the system DC bus, but it has completed all preparatory steps required for rapid activation.

When the inverter block controller issues an activation command, the pack manager enters an Activating state. During the Activating state, the pack manager performs pre-charge and pre-connection checks, verifies the DC/DC voltage alignment between the battery pack and the DC bus, and ensures that all battery pack parameters lie within a defined safe operating window. In some embodiments, the pack manager sequences contactor closure to avoid inrush currents or unsafe voltage differentials.

After the activation criteria are met, the pack manager enters an Active state. In the Active state, the pack manager closes the battery pack contactors and enables the isolated DC/DC converter. Moreover, the pack manager participates in DC droop control according to a commanded droop slope received from the inverter block controller. While in the Active state, the pack manager continuously monitors battery pack health, temperature, voltage limits, and internal BMS alerts.

In some cases, the pack manager transitions from the Active state to a Deactivating state. For example, if the pack manager detects an operational fault associated with the battery pack, the pack manager transitions to the Deactivating state. In addition, if the battery energy storage system 200 issues a control command to withdraw the battery pack from the system (e.g., for pack balancing, maintenance, thermal limits, or operational scheduling), the pack manager transitions to the Deactivating state. During the Deactivating state, the pack manager gradually reduces current contribution from the battery pack via controlled DC droop adjustments, ensures the current approaches zero, and then opens the battery pack contactors in a defined sequence. Following a safe disengagement of the battery pack from the DC bus, the pack manager transitions to the Faulted State.

The pack manager enters the Faulted state when a safety-critical error is detected. For example, the pack manager enters the Faulted state from the Deactivating State or from the Startup state. In some cases, the pack manager enters the Faulted state due to faults such as over-voltage, under-voltage, over-temperature, excessive current, isolation faults, or internal pack manager diagnostics failures. In the Faulted state, the pack manager electrically isolates its battery pack from the system (e.g., opens the battery pack contactors and disables the isolated DC/DC). After resolution of the Faulted state, the pack manager returns to the Standby state.

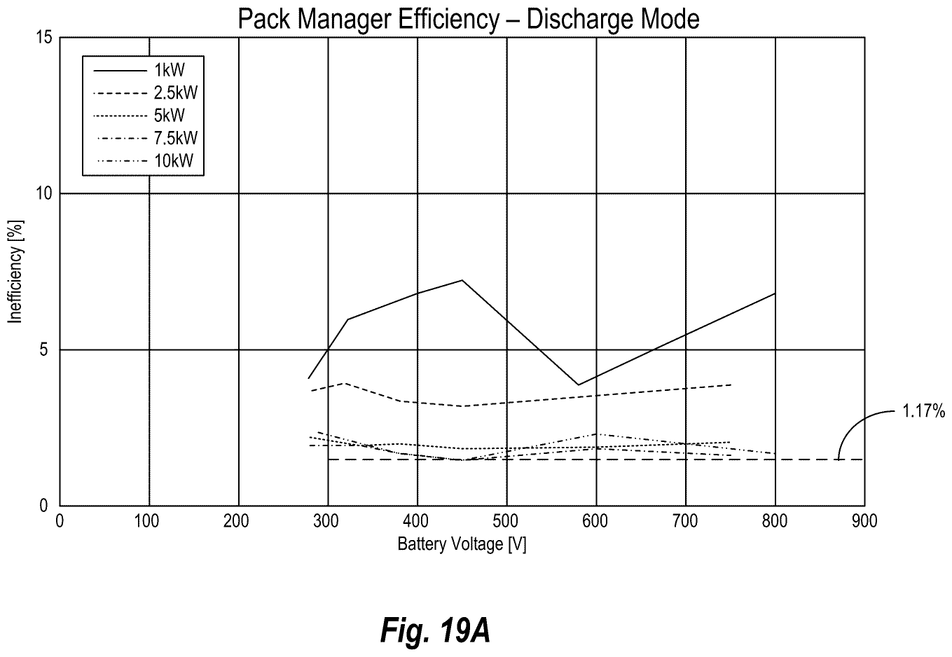

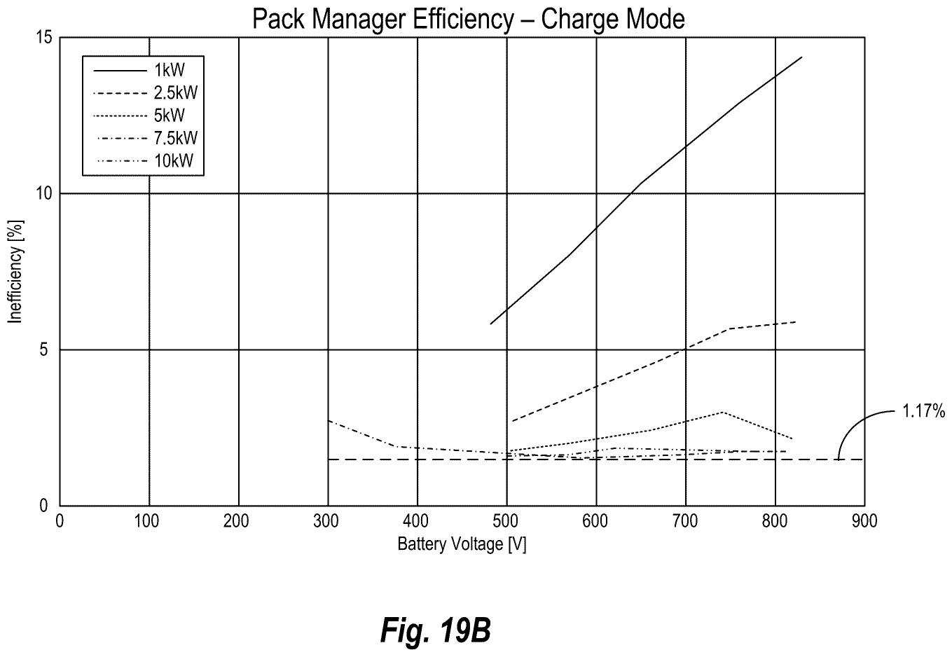

As mentioned, in one or more embodiments, the battery energy storage system 200 utilizes pack managers to manage efficient charging and discharging of a plurality of disparate battery packs. FIGS. 19A-19B illustrate graphs that quantify pack manager efficiency for the battery energy storage system 200 in accordance with one or more embodiments.

As illustrated in FIG. 19A, the power-conversion performance of the pack managers can be characterized using a graph of inefficiency versus battery voltage, from which overall efficiency for discharging and charging the disparate battery packs can be modeled across different load levels.

As illustrated in FIG. 19A, the implementation of the pack managers by the battery energy storage system 200 demonstrates an efficient use of the disparate second-life battery packs. As shown, at the 5 kW power stage, 7.5 kW power stage, and 10 kW power stage, the pack manager exhibits high discharge mode efficiency trending close to approximately 98.3% efficiency across the battery pack voltage range (e.g., 1.17% inefficiency). The graph further indicates that lower power stages also maintain favorable efficiency characteristics (e.g., the 1 kW stage exhibits a measured efficiency of 93-96%). Notably, although the low-power operating stages are less efficient, because the battery energy storage system 200 nominally cycles the disparate second-life battery packs at or near full power during discharge intervals, the 10 kW power stage efficiency dominates energy throughput for the battery energy storage system 200.

Similarly, as illustrated in FIG. 19B, the implementation of the pack managers by the battery energy storage system 200 demonstrates an efficient charge mode corresponding to the disparate second-life battery packs. As shown, at the 5 kW power stage, 7.5 kW power stage, and 10 kW power stage, the pack manager exhibits high charge mode efficiency trending close to approximately 98.3% efficiency across the battery pack voltage range (e.g., 1.17% inefficiency). The graph further indicates that lower power stages also maintain favorable efficiency characteristics (e.g., the 1 kW stage exhibits a measured efficiency of the 94-97%). Notably, although the low-power operating stages are less efficient, because the battery energy storage system 200 nominally cycles the disparate second-life battery packs at or near full power during charge intervals, the 10 kW power stage efficiency dominates energy throughput for the battery energy storage system 200.

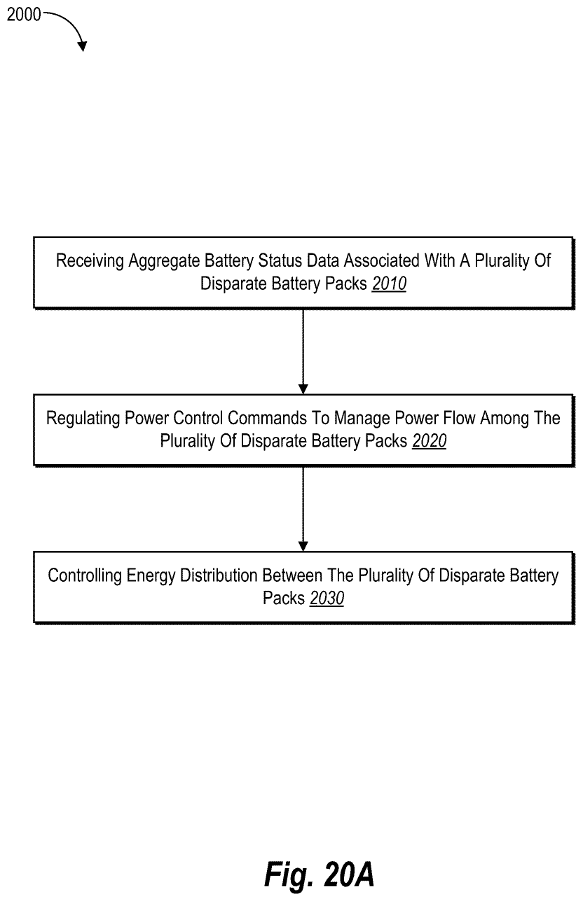

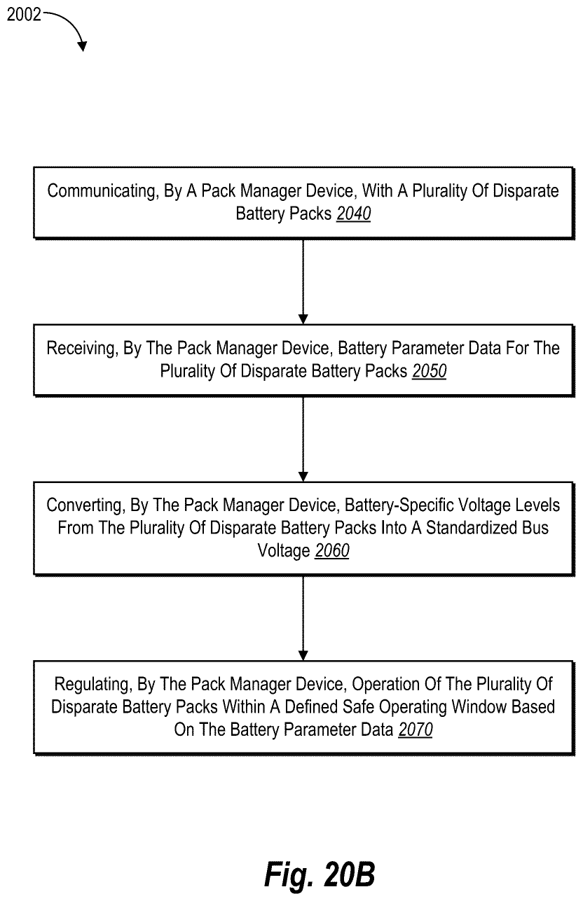

In addition to the foregoing, one or more embodiments can also be described in terms of flowcharts comprising acts for accomplishing a particular result, as shown in In addition to the foregoing, one or more embodiments can also be described in terms of flowcharts comprising acts for accomplishing a particular result, as shown in FIGS. 20A-20B. The acts shown in FIGS. 20A-20B may be performed in connection with more or fewer acts. Further, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIGS. 20A-20B. In some embodiments, a system can be configured to perform the acts of FIGS. 20A-20B. Alternatively, the acts of FIGS. 20A-20B can be performed as part of a computer-implemented method. While FIGS. 20A-20B illustrates acts according to one embodiment, alternative embodiments may omit, add to, reorder, and/or modify any acts shown in FIGS. 20A-20B.

FIG. 20A illustrates a flowchart of a series of acts 2000 for controlling energy distribution between a plurality of disparate battery packs in accordance with one or more embodiments. In certain embodiments, the series of acts 2000 includes an act 2010 of receiving aggregate battery status data associated with a plurality of disparate battery packs. In particular, the act 2010 involves receiving, by a site controller, aggregate battery status data corresponding to a plurality of battery management systems respectively associated with a plurality of disparate battery packs, wherein battery packs of the plurality of disparate battery packs comprise second-life electric vehicle battery packs from differing manufacturers with differing electrical characteristics, energy capacities, and communication protocols.

The series of acts can also include an act 2020 of regulating power control commands to manage power flow among the plurality of disparate battery packs. In particular, the act 2020 can include regulating, by the site controller, power control commands for one or more inverter blocks configured to manage power flow among the plurality of disparate battery packs based on the aggregate battery status data. The series of acts 2000 can also include an act 2030 of controlling energy distribution between the plurality of disparate battery packs. In particular, the act 2030 involves controlling, by the site controller, energy distribution between the plurality of disparate battery packs and one or more loads according to power requirements of an energy management system.

In some embodiments, the series of acts 2000 includes an act of receiving, by the site controller, state-of-charge data, voltage data, current data, and temperature data from the plurality of battery management systems associated with the plurality of disparate battery packs. The series of acts 2000 can also include prioritizing energy contribution from one or more battery packs based on a state-of-health or available capacity. The series of acts 2000 can also include balancing charge levels among the plurality of disparate battery packs to maintain a uniform state-of-charge among the plurality of disparate battery packs.

In certain embodiments, the series of acts 2000 includes an act of detecting, by the site controller, a fault condition associated with one of the plurality of disparate battery packs and issuing a control command to isolate a corresponding inverter block of the one or more inverter blocks from the energy management system. The series of acts 2000 can also include coordinating operation of multiple inverter blocks each associated with a different subset of the plurality of disparate battery packs.

FIG. 20B illustrates a flowchart of a series of acts 2002 for regulating, by a pack manager device, operation of the plurality of disparate battery packs within a defined safe operating window in accordance with one or more embodiments. In certain embodiments, the series of acts 2002 includes an act 2040 of communicating, by a pack manager device, with a plurality of disparate battery packs. In particular, the act 2040 involves communicating, by a pack manager device, with a plurality of battery management systems associated with a plurality of disparate battery packs to exchange control signals and status signals, wherein the plurality of disparate battery packs comprise differing electrical characteristics, energy capacities, and communication protocols. The series of acts can also include an act 2050 of receiving, by the pack manager device, battery parameter data for the plurality of disparate battery packs. In particular, the act 2050 can include receiving, by the pack manager device, battery parameter data from the plurality of battery management systems, the battery parameter data including at least voltage data, current data, temperature data, and state-of-charge data for each of the plurality of disparate battery packs.

The series of acts 2000 can also include an act 2060 of converting, by the pack manager device, battery-specific voltage levels from the plurality of disparate battery packs into a standardized bus voltage. In particular, the act 2060 involves converting, by a power conversion interface of the pack manager device, battery-specific voltage levels from the plurality of disparate battery packs into a standardized bus voltage for transfer to a system direct-current bus. The series of acts can also include an act 2070 of regulating, by the pack manager device, operation of the plurality of disparate battery packs within a defined safe operating window based on the battery parameter data. In particular, the act 2070 can include regulating, by a control processor of the pack manager device, operation of the plurality of disparate battery packs within a defined safe operating window based on the battery parameter data received from the plurality of battery management systems, including adjusting current flow through the power conversion interface to maintain balanced power transfer among the plurality of disparate battery packs.

In some embodiments, the series of acts 2002 includes an act of executing, by the pack manager device, one or more predetermined operational modes for each of the plurality of disparate battery packs, the one or more predetermined operational modes comprising safe startup, shutdown, standby, charging, and discharging. The series of acts 2002 can also include adjusting current flow through the power conversion interface to equalize state-of-charge across the plurality of disparate battery packs. The series of acts 2002 can also include limiting charge or discharge current when a pack temperature or cell voltage exceeds a predefined threshold.

In certain embodiments, the series of acts 2002 includes an act of dynamically prioritizing power contributions for the plurality of disparate battery packs according to differences in battery chemistry, battery charging capabilities, or battery state-of health. The series of acts 2002 can also include reporting state-of-charge for the plurality of disparate battery packs comprising current data, voltage data, and temperature data received from the plurality of battery management systems.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

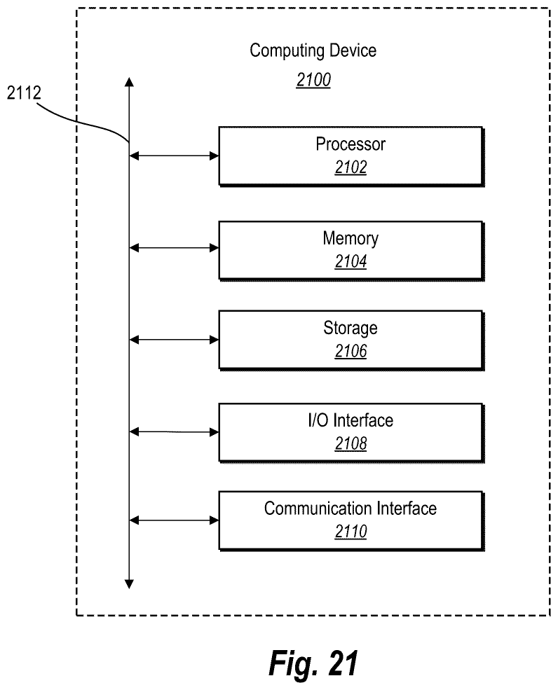

FIG. 21 illustrates a block diagram of an example computing device 2100 that may be configured to perform one or more of the processes described above. One will appreciate that one or more computing devices, such as the computing device 2100 may represent the computing devices described above. In one or more embodiments, the computing device 2100 may be a mobile device (e.g., a mobile telephone, a smartphone, a PDA, a tablet, a laptop, a camera, a tracker, a watch, a wearable device, etc.). In some embodiments, the computing device 2100 may be a non-mobile device (e.g., a desktop computer or another type of client device). Further, the computing device 2100 may be a server device that includes cloud-based processing and storage capabilities.

As shown in FIG. 21, the computing device 2100 can include one or more processor(s) 2102, memory 2104, a storage device 2106, I/O interfaces 2108 (or “input/output interfaces”), and a communication interface 2110, which may be communicatively coupled by way of a communication infrastructure (e.g., bus 2112). While the computing device 2100 is shown in FIG. 21, the components illustrated in FIG. 8 are not intended to be limiting. Additional or alternative components may be used in other embodiments. Furthermore, in certain embodiments, the computing device 2100 includes fewer components than those shown in FIG. 21. Components of the computing device 2100 shown in FIG. 21 will now be described in additional detail.

In particular embodiments, the processor(s) 2102 includes hardware for executing instructions, such as those making up a computer program. As an example, and not by way of limitation, to execute instructions, the processor(s) 2102 may retrieve (or fetch) the instructions from an internal register, an internal cache, memory 2104, or a storage device 2106 and decode and execute them.

The computing device 2100 includes memory 2104, which is coupled to the processor(s) 2102. The memory 2104 may be used for storing data, metadata, and programs for execution by the processor(s). The memory 2104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 2104 may be internal or distributed memory.

The computing device 2100 includes a storage device 2106 includes storage for storing data or instructions. As an example, and not by way of limitation, the storage device 2106 can include a non-transitory storage medium described above. The storage device 2106 may include a hard disk drive (HDD), flash memory, a Universal Serial Bus (USB) drive or a combination these or other storage devices.

As shown, the computing device 2100 includes one or more I/O interfaces 2108, which are provided to allow a user to provide input to (such as user strokes), receive output from, and otherwise transfer data to and from the computing device 2100. These I/O interfaces 2108 may include a mouse, keypad or a keyboard, a touch screen, camera, optical scanner, network interface, modem, other known I/O devices or a combination of such I/O interfaces 2108. The touch screen may be activated with a stylus or a finger.

The I/O interfaces 2108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 2108 are configured to provide graphical data to a display for presentation to a user. The graphical data may be representative of one or more graphical user interfaces and/or any other graphical content as may serve a particular implementation.

The computing device 2100 can further include a communication interface 2110. The communication interface 2110 can include hardware, software, or both. The communication interface 2110 provides one or more interfaces for communication (such as, for example, packet-based communication) between the computing device and one or more other computing devices or one or more networks. As an example, and not by way of limitation, communication interface 2110 may include a network interface controller (NIC) or network adapter for communicating with an Ethernet or other wire-based network or a wireless NIC (WNIC) or wireless adapter for communicating with a wireless network, such as a WI-FI. The computing device 2100 can further include a bus 2112. The bus 2112 can include hardware, software, or both that connects components of computing device 2100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A pack manager device comprising:
a communication interface operable to exchange control signals and status signals with a plurality of disparate electrical vehicle battery packs with differing electrical characteristics, energy capacities, and communication protocols;
a power conversion interface operable to transfer power between the plurality of disparate electrical vehicle battery packs and a system direct-current bus by converting battery-specific voltage levels into a standardized bus voltage; and
a control processor operable to regulate operation of the plurality of disparate electrical vehicle battery packs within a defined safe operating window based on battery parameter data received from a plurality of battery management systems corresponding to the plurality of disparate electrical vehicle battery packs.

2. The pack manager device of claim 1, wherein the power conversion interface is further operable to regulate current limits for the plurality of disparate electrical vehicle battery packs based on disparate operating conditions corresponding to the plurality of disparate electrical vehicle battery packs.

3. The pack manager device of claim 1, wherein the control processor is further operable to report a state-of-charge for a battery pack of the plurality of disparate electrical vehicle battery packs comprising current data, voltage data, and temperature data received from a battery management system of the plurality of battery management systems that corresponds to the battery pack.

4. The pack manager device of claim 1, wherein the communication interface is further operable to:
detect a first communication protocol of a first electrical vehicle battery pack upon connection of the first electrical vehicle battery pack to the pack manager device; and
detect a second communication protocol of a second electrical vehicle battery pack upon connection of the second electrical vehicle battery pack to the pack manager device.

5. The pack manager device of claim 1, wherein the control processor is further operable to regulate power transfer between the system direct-current bus and each of the plurality of disparate electrical vehicle battery packs based on a droop control parameter that compensates for differences between the plurality of disparate electrical vehicle battery packs, including variations resulting from differing manufacturers, battery pack chemistries, or battery pack degradation levels.

6. The pack manager device of claim 1, wherein the power conversion interface is further operable to provide galvanic isolation between the plurality of disparate electrical vehicle battery packs and the system direct-current bus to accommodate electrical differences and battery pack degradation levels among the plurality of disparate electrical vehicle battery packs.

7. The pack manager device of claim 1, wherein the power conversion interface is further operable to disconnect an individual electrical vehicle battery pack of the plurality of disparate electrical vehicle battery packs from the system direct-current bus in response to a fault condition.

8. The pack manager device of claim 1, wherein the control processor is further operable to regulate the operation of the plurality of disparate electrical vehicle battery packs in outdoor environments across a range of ambient temperatures within the defined safe operating window.

9. The pack manager device of claim 1, wherein the control processor is further operable to:
apply dynamic load adjustments to a battery pack by varying charge or discharge current to evaluate electrical response characteristics of the battery pack; and
compute voltage deviation metrics based on differences between expected voltage values and measured voltage values for the battery pack.

10. A battery energy storage system comprising:
a first electrical vehicle battery pack having a first operating voltage range and a first communication protocol;
a second electrical vehicle battery pack having a second operating voltage range different from the first operating voltage range; and
a pack manager device operable to provide a standardized electrical and communication interface between the first electrical vehicle battery pack, the second electrical vehicle battery pack, and a system direct-current bus, the pack manager device comprising:
a communication interface operable to exchange control signals with the first electrical vehicle battery pack and the second electrical vehicle battery pack;
a power conversion interface operable to transfer power to a system direct-current bus by converting battery-specific voltage levels from the first electrical vehicle battery pack and the second electrical vehicle battery pack into a standardized bus voltage; and
a control processor operable to receive battery parameter data from a first battery management system for the first electrical vehicle battery pack and a second battery management system for the second electrical vehicle battery pack.

11. The battery energy storage system of claim 10, wherein the control processor is operable to:
detect a degradation rate for the first electrical vehicle battery pack based on threshold criteria comprising voltage variation, voltage deviation, or response time; and
transmit control signals to the first battery management system to halt, rest or limit usage of the first electrical vehicle battery pack.

12. The battery energy storage system of claim 10, wherein the control processor is operable to adjust operation of the pack manager device based on differences in battery chemistry between the first electrical vehicle battery pack and the second electrical vehicle battery pack.

13. The battery energy storage system of claim 10, wherein the power conversion interface comprises:
a first isolated DC/DC operable to provide galvanic isolation for the first electrical vehicle battery pack and convert battery-specific voltages of the first electrical vehicle battery pack to the standardized bus voltage; and
a second isolated DC/DC operable to provide galvanic isolation for the second electrical vehicle battery pack and convert battery-specific voltages of the second electrical vehicle battery pack to the standardized bus voltage.

14. The battery energy storage system of claim 10, wherein the first electrical vehicle battery pack and the second electrical vehicle battery pack have different charging capabilities comprising differing allowable charge currents, charge-rate limits, or charge control parameters.

15. A method comprising:
communicating, by a pack manager device, with a plurality of battery management systems associated with a plurality of disparate battery packs to exchange control signals and status signals, wherein the plurality of disparate battery packs comprise differing electrical characteristics, energy capacities, and communication protocols;
receiving, by the pack manager device, battery parameter data from the plurality of battery management systems, the battery parameter data including at least voltage data, current data, temperature data, and state-of-charge data for each of the plurality of disparate battery packs;
converting, by a power conversion interface of the pack manager device, battery-specific voltage levels from the plurality of disparate battery packs into a standardized bus voltage for transfer to a system direct-current bus; and
regulating, by a control processor of the pack manager device, operation of the plurality of disparate battery packs within a defined safe operating window based on the battery parameter data received from the plurality of battery management systems, including adjusting current flow through the power conversion interface to maintain balanced power transfer among the plurality of disparate battery packs.

16. The method of claim 15, further comprising executing, by the pack manager device, one or more predetermined operational modes for each of the plurality of disparate battery packs, the one or more predetermined operational modes comprising safe startup, shutdown, standby, charging, and discharging.

17. The method of claim 15, wherein regulating operation of the plurality of disparate battery packs comprises adjusting current flow through the power conversion interface to equalize state-of-charge across the plurality of disparate battery packs.

18. The method of claim 15, wherein regulating operation of the plurality of disparate battery packs comprises limiting charge or discharge current when a pack temperature or cell voltage exceeds a predefined threshold.

19. The method of claim 15, wherein regulating operation of the plurality of disparate battery packs comprises dynamically prioritizing power contributions for the plurality of disparate battery packs according to differences in battery chemistry, battery charging capabilities, or battery state-of health.

20. The method of claim 15, further comprising reporting state-of-charge for the plurality of disparate battery packs comprising current data, voltage data, and temperature data received from the plurality of battery management systems.
